(19) United States
(12) Patent Application Publication
(10) Pub. No.: US 2010/0092784 A1
(43) Pub. Date: Apr. 15, 2010

(54) OPTICAL FILM, AND GLASS

(75) Inventors: Koh Kamada, Kanagawa (JP); Yuki Matsunami, Kanagawa (JP)

Correspondence Address: AKERMAN SENTERFITT, 8100 BOONE BOULEVARD, SUITE 700, VIENNA, VA, 22182-2683, US

(73) Assignee: FUJIFILM CORPORATION, Tokyo (JP)

(21) Appl. No.: 12/448,043

(22) PCT Filed: Nov. 26, 2007
(86) PCT No.: PCT/JP2007/073272

§ 371 Date: Jun. 5, 2009

(30) Foreign Application Priority Data
Dec. 8, 2006 (JP) 2006-331498

(51) Int. Cl. B32B 17/06; G02B 5/30; H01J 5/16

(52) U.S. Cl. 428/426; 359/485; 359/490; 313/112

(57) ABSTRACT

The present invention provides an optical film having a phase difference film, and a polarized film formed on both surfaces of the phase difference film, wherein the polarized film contains at least a polarizer, and the absorption axis of the polarizer is substantially perpendicularly oriented to the polarized film surface. The present invention also provides a glass using the optical film.

### CROSS-REFERENCE TO RELATED APPLICATIONS

The present invention is a 35 USC 371 national stage entry of PCT/JP2007/073272, filed Nov. 26, 2007, which claims priority from Japanese Patent Application No. 2006-331498, filed Dec. 8, 2006, the contents of which are herein incorporated by reference in their entirety.

### TECHNICAL FIELD

The present invention relates to an optical film suitably used for plasma displays, liquid crystal displays and glass building materials and the like and also relates to a glass using the optical film.

### BACKGROUND ART

Conventionally, various heat ray reflecting glasses have been proposed which can reduce stress or burden incurred from air-conditioning equipment by reflecting and absorbing radiant heat sunlight and conditioning environmental conditions such as room temperature (for example, see Patent Literature 1 to Patent Literature 3).

Because those heat ray reflecting glasses are highly efficient in blocking radiant heat of sunlight and have energy saving effect and a high transmittance to visible light, they can keep indoor rooms bright. Further, those heat ray reflecting glass also have a high reflectance to visible light and specular effects and can provide new esthetic appearance to architectural structures, and thus they have become essential in designing of modern buildings.

The heat ray reflecting glass can be obtained, for example, by forming a metal such as Au, Ag, Al, Cu, Ni, Cr, Fe, Ti and Zr as a simple material or a thin film of a metal oxide on a glass surface. As a production method of the thin film, vacuum evaporation method or sputtering method is mainly used. For this reason, it is necessary to set up large-scale production equipment, causing a problem with an increase in production cost.

Further, Non-Patent Literature 1 discloses a polarized film that seems to have a perpendicularly oriented polarizer from the viewpoint of the production method and dichroic data. However, with use of only the polarized film disclosed in Non-Patent Literature 1, the light shielding degree from oblique directions is insufficient, and the present situation is that further improvements are needed.

Patent Literature 1 Japanese Patent Application Laid-Open (JP-A) No. 7-10609

Patent Literature 2 Japanese Patent Application Laid-Open (JP-A) No. 8-171015

Patent Literature 3 Japanese Patent Application Laid-Open (JP-A) No. 9-301741

Non-Patent Literature 1 Chemical Physics Letters 398 (2004) pp. 224-227

### DISCLOSURE OF INVENTION

The present invention aims to provide an optical film that can drastically reduce light intrusion into indoor rooms from outside by placing the optical film at the front of a plasma display or a liquid crystal display to thereby improve brightness contrast in the room and can absorb sunlight incoming from oblique directions, when used as building glass such as windowpane, the optical film allows for absorbing sunlight incoming from oblique directions to thereby prevent increases in room temperature and also allows for exhibiting an excellent partition effect that indoor rooms can be seen from the front view but cannot be seen from oblique angles because the indoors are seen as darkness, and the present invention also aims to provide a glass using the optical film.

The means for solving aforesaid problems are as follows:

<1> An optical film having a phase difference film and a polarized film on both surfaces of the phase difference film, wherein the polarized film contains at least a polarizer, and the absorption axis of the polarizer is substantially perpendicularly oriented to the polarized film surface.

Because the optical film according to the item <1> has a polarized film on both surfaces of a phase difference film, the polarized film contains at least a polarizer, and the absorption axis of the polarizer is substantially perpendicularly oriented to the polarized film surface, it is possible to absorb light from oblique directions without having absorption of visible light from the front view, to drastically reduce light intrusion into indoor rooms from outside light by placing the optical film at the front of a plasma display or a liquid crystal display to thereby improve brightness contrast in the room, and when used as building glass such as windowpane, the optical film allows for preventing increases in room temperature and exhibiting an excellent effect of preventing peeping. When the optical film of the present invention is used as a partition, peeping from oblique directions can be prevented.

<2> The optical film according to the item <1>, wherein the phase difference film is a half-wavelength plate.

<3> The optical film according to any one of the items <1> to <2>, wherein the absorption axis of the polarizer is oriented at an angle of 80 degrees to 90 degrees to the polarized film surface.

<4> The optical film according to any one of the items <1> to <3>, wherein the polarizer contains an anisotropically absorbing material.

<5> The optical film according to the item <4>, wherein the anisotropically absorbing material is any one of a dichroic pigment, an anisotropic metal nano particle and a carbon nanotube.

<6> The optical film according to the item <5>, wherein the material of the anisotropic metal nano particle is at least one selected from gold, silver, copper and aluminum.

<7> The optical film according to any one of the items <1> to <6>, being placed at the front of a plasma display or a liquid crystal display.

<8> A glass having a substrate and an optical film according to any one of the items <1> to <6>, wherein when the glass is placed so that sunlight is incident from one surface of the substrate, the optical film is formed on the surface of the substrate on which sunlight is not incident on.

<9> The glass according to the item <8>, wherein the substrate is a laminated glass in which an intermediate layer is formed in between two sheets of plate glasses, and the intermediate layer contains the optical film.

### BRIEF DESCRIPTION OF DRAWINGS

FIG. 1A is a plane view showing an orientation state of a polarizer in a polarized film surface.

FIG. 1B is a cross-sectional view at the A-A line of the polarizer in FIG. 1A.

FIG. 1C is another cross-sectional view at the A-A line of the polarizer in FIG. 1A.

FIG. 2 is a view showing a gold nanorod absorption spectrum.

FIG. 3 is a schematic cross-sectional view showing one example of the glass of the present invention.

FIG. 4 is a view showing one example in which the optical film of the present invention is provided as an intermediate layer of a laminated glass.

FIG. 5 is a view showing another example in which the optical film of the present invention is provided as an intermediate layer of a laminated glass.

FIG. 6 is a view explaining one example of the optical film of the present invention.

FIG. 7 is a graph showing measurement results of transmittance of the optical film of Example 1 while changing the light incident angle to the optical film.

FIG. 8 is a concentric graph of results of the transmittance of the optical film of Example 1 measured in all azimuthal directions.

### BEST MODE FOR CARRYING OUT THE INVENTION

### Optical Film

The optical film of the present invention has a phase difference film and a polarized film on both surfaces of the phase difference film and further has other structures in accordance with necessity.

### <Polarized Film>

The polarized film contains at least a polarizer and further contains other components such as dispersing agents, solvents, and binder resins.

### —Polarizer—

The absorption axis of the polarizer is substantially perpendicularly oriented to the polarized film surface. By orienting the absorption axis of the polarizer in a substantially perpendicular direction to the polarized film surface (horizontal surface) as above, the film has a high transmittance as seen from the front view, and when the film is seen from oblique directions, it has a low transmittance because only lateral light can pass through the optical film from oblique directions.

The absorption axis of the polarizer means an axis that is parallel to a direction in which the absorptance becomes the lowest value when the polarizer is observed from all the directions.

The term “substantially perpendicular direction” means that the absorption axis of the polarizer is oriented at an angle of 80 degrees to 90 degrees to the polarized film surface (horizontal surface). The absorption axis of the polarizer is preferably oriented at an angle of 85 degrees to 90 degrees and more preferably oriented perpendicularly (at an angle of 90 degrees) to the polarized film surface. When the angle of the absorption axis of the polarizer to the polarized film surface is less than 80 degrees, the transmittance as seen from the front view may decrease.

Here, whether or not the absorption axis of the polarizer is oriented in a substantially perpendicular direction to the horizontal reference plane of the polarized film can be checked by observing the cross-section of the polarized film through a transmission electron microscope (TEM).

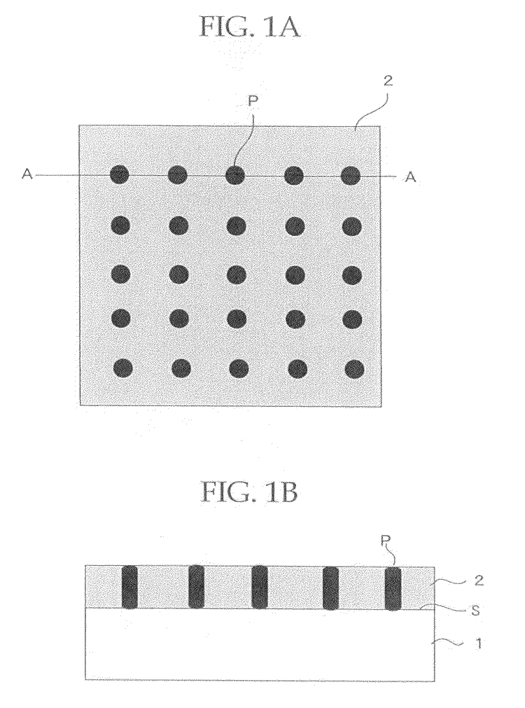

The orientation state of the polarizer will be explained in detail with reference to figures. FIG. 1A is a plane view showing an orientation state of a polarizer P in a polarized film 2. FIG. 1B is a cross-sectional view at the A-A line in FIG. 1A. FIG. 1C is another cross-sectional view at the A-A line in FIG. 1A. As shown in FIGS. 1A to 1B, the absorption axis of the polarizer P is oriented in the perpendicular direction (at 90 degrees) to a horizontal surface S. In FIG. 1C, the absorption axis of the polarizer P is oriented in a substantially perpendicular direction (at 80 degrees to 90 degrees) to the horizontal surface S.

When the polarizer is composed of an inorganic particle, the average aspect ratio is 1.5 or more, preferably 1.6 or more, and still more preferably 2.0 or more. When the average aspect ratio is 1.5 or more, the polarizer can exert a sufficient anisotropically absorbing effect.

Here, the average aspect ratio of the polarizer can be determined by measuring the major axis length and the minor axis length of the polarizer and using the following expression, (the major axis length of the polarizer)/(the minor axis length of the polarizer).

The minor axis length of the polarizer is not particularly limited and may be suitably selected in accordance with the intended use, however, it is preferably 1 nm to 50 nm and more preferably 5 nm to 30 nm. The major axis of the polarizer is not particularly limited and may be suitably selected in accordance with the intended use, however, it is preferably 10 nm to 1,000 nm and more preferably 10 nm to 100 nm.

The polarizer is not particularly limited and may be suitably selected in accordance with the intended use. For the polarizer, dichroic pigments, anisotropic metal nano particles, carbon nanotubes and metal complexes are exemplified. Of these, dichroic dyes, anisotropic metal nano particles and carbon nanotubes are particularly preferable.

### —Dichroic Pigment—

Examples of the dichroic pigment include azo pigments and anthraquinone pigments. Each of these may be used alone or in combination with two or more.

In the present invention, the dichroic pigment is defined as a compound having a light absorption function. The dichroic pigment may have any absorption maximum and light absorption band, however, a dichroic pigment having an absorption maximum in the yellow region (Y), magenta region (M) or cyan region (C) is preferably used. Two or more dichroic pigments may be used, it is preferable to use a mixture of dichroic pigments having an absorption maximum at Y, M and C regions, and it is more preferable to mix dichroic pigments so as to absorb all the visible regions (400 nm to 750 nm) for use. Here, the yellow region covers a range of 430 nm to 500 nm, the magenta region covers 500 nm to 600 nm, and the cyan region covers 600 nm to 750 nm.

Here, a chromophore group used for the dichroic pigments will be explained below. The chromophore group of the dichroic pigments is not particularly limited and may be suitably selected in accordance with the intended use. Examples thereof include azo pigments, anthraquinone pigments, perylene pigments, merocyanine pigments, azomethine pigments, phthalocyanine pigments, indigo pigments, azulene pigments, dioxazine pigments, polythiophene pigments, and phenoxazine pigments (phenoxazine-3-on). Of these, azo pigments, anthraquinone pigments and phenoxazine pigments (phenoxazine-3-on) are particularly preferable.

Examples of the azo pigments include monoazo pigments, bisazo pigments, trisazo pigments, tetrakisazo pigments, and pentakisazo pigments. Of these, monoazo pigments, bisazo pigments, and trisazo pigments are particularly preferable.

The ring structure contained in the azo pigment may be, besides aromatic group (benzene ring, naphthalene ring, etc.), heterocyclic (quinoline ring, pyridine ring, thiazole ring, benzothiazole ring, oxazole ring, benzooxazole ring, imidazole ring, benzimidazole ring, pyrimidine ring, etc.).

Substituent groups of the anthraquinone pigment preferably contain an oxygen atom, a sulfur atom or a nitrogen atom. For example, alkoxy group, aryloxy group, alkylthio group, arylthio group, alkylamino group, and arylamino group. The number of the substituent groups is not particularly limited, however, di-substitution, tri-substitution, and tetrakis substitution are preferable. Di-substitution and tri-substitution are particularly preferable. The substituent group may be substituted at any sites, however, it is preferably 1,4-di-substituted structure, 1,5-di-substituted structure, 1,4,5-tri-substituted structure, 1,2, 4-tri-substituted structure, 1,2,5-tri-substituted structure, 1,2,4,5-tetra-substituted structure or 1,2,5,6-tetra-substituted structure.

For the substituent group of the phenoxazone pigment (phenoxazine-3-on), it preferably contain an oxygen atom, a sulfur atom or a nitrogen atom, and examples thereof include alkoxy group, aryloxy group, alkylthio group, arylthio group, alkylamino group and arylamino group.

The dichroic pigments used in the present invention preferably have a substituent group represented by the following General Formula (1).

-(Het)ⱼ-{(B¹)ₚ-(Q¹)_{q}-(B²)ᵣ}ₙ—C¹ General Formula (1)

However, in the General Formula (1), “Het” represents an oxygen atom or a sulfur atom; B¹ and B² respectively represent an allylene group, a hetero allylene group or a divalent cyclic aliphatic hydrocarbon group; Q¹ represents a divalent bound group; C¹ represents an alkyl group, a cycloalkyl group, an alkoxy group, an alkoxy carbonyl group, an acyl group or an acyloxy group; “j” represents an integer of 0 or 1; “p”, “q” or “r” respectively represent an integer of 0 to 5; “n” represents an integer of 1 to 3; (p+r)×n=an integer of 3 to 10, i.e., a value of “p” plus “r” multiplied by an integer of “n” is an integer any one of integers 3 to 10, when “p”, “q” or “r” is 2 or more, each of {(B¹)ₚ-(Q¹)_{q}-(B²)ᵣ} being 2 or more, may be the same to each other or different from each other, and when “n” is an integer of 2 or more, each of {(B¹)ₚ-(Q¹)_{q}-(B²)ᵣ} being 2 or more, may be the same to each other or different from each other.

“Het” is an oxygen atom or a sulfur atom and particularly preferably a sulfur atom.

B¹ and B² respectively represent an allylene group, a heteroallylene group or a divalent cyclic aliphatic hydrocarbon group, and both of them need not have a substituent group.

The allylene group represented by B¹ or B² is preferably an allylene group having 6 to 20 carbon atoms, more preferably having 6 to 10 carbon atoms. Preferred allylene groups are groups of benzene ring, naphthalene ring and anthraquinone group, for example. More preferred allylene groups are groups of benzene ring and substituted benzene ring, and still more preferred allylene group is 1,4-phenylene group.

The heteroallylene group represented by B¹ or B² is preferably a heteroallylene group having 1 to 20 carbon atoms and more preferably a heteroallylene group having 2 to 9 carbon atoms. Preferred examples of the heteroallylene group include groups of pyridine ring, quinoline ring, isoquinoline group, pyrimidine ring, pyrazine ring, thiophene ring, furan ring, oxazole ring, thiazole ring, imidazole ring, pyrazole ring, oxadiazole ring, thiadiazole ring or triazole ring, and condensed heteroallylene groups formed by condensation of the above-mentioned groups.

The divalent cyclic aliphatic hydrocarbon group represented by B¹ or B² is preferably a divalent cyclic aliphatic hydrocarbon group having 3 to 20 carbon atoms and more preferably having 4 to 10 carbon atoms. Preferred divalent cyclic aliphatic hydrocarbon groups are, for example, cyclohexanediyl and cyclopentanediyl, more preferred divalent cyclic aliphatic hydrocarbon groups are cyclohexane-1,2-diyl group, cyclohexane-1,3-diyl group, cyclohexane-1,4-diyl group, cyclopentane-1,3-diyl group, and particularly preferred divalent cyclic aliphatic hydrocarbon group is cyclohexane-1,4-diyl group.

Each of the divalent allylene group, the heteroallylene group and the divalent cyclic aliphatic hydrocarbon group represented by B¹ or B² may further have a substituent group. Examples of the substituent group include the following substituent groups V.

### <Substituent Group V>

Halogen atoms (for example, chlorine atom, bromine atom, iodine atom, and fluorine atom); mercapto groups, carboxy groups, phosphoric groups; sulfo groups; hydroxy groups; carbamoyl groups having 1 to 10 carbon atoms, preferably having 2 to 8 carbon atoms, and more preferably having 2 to 5 carbon atoms (for example, methylcarbamoyl groups, ethylcarbamoyl group, and morpholino carbamoyl group); sulfamoyl groups having 0 to 10 carbon atoms, preferably having 2 to 8 carbon atoms, and more preferably having 2 to 5 carbon atoms (for example, methylsulfamoyl group, ethylsulfamoyl group, and piperidinosulfonyl group); nitro groups; alkoxy groups having 1 to 20 carbon atoms, preferably having 1 to 10 carbon atoms, and more preferably having 1 to 8 carbon atoms (for example, methoxy group, ethoxy group, 2-methoxyethoxy group, and 2-phenylethoxy group); aryloxy groups having 6 to 20 carbon atoms, preferably having 6 to 12 carbon atoms, and more preferably having 6 to 10 carbon atoms (for example, phenoxy group, p-methylphenoxy group, p-chlorophenoxy group, and naphthoxy group); acyl groups having 1 to 20 carbon atoms, preferably having 2 to 12 carbon atoms, and more preferably having 2 to 8 carbon atoms (for example, acetyl group, benzoyl group, and trichloroacetyl group); acyloxy groups having 1 to 20 carbon atoms, preferably having 2 to 12 carbon atoms, and more preferably having 2 to 8 carbon atoms (for example acetyloxy group and benzoyloxy group); acylamino groups having 1 to 20 carbon atoms, preferably having 2 to 12 carbon atoms, and more preferably having 2 to 8 carbon atoms (for example acetylamino group); sulfonyl groups having 1 to 20 carbon atoms, preferably having 1 to 10 carbon atoms, and more preferably having 1 to 8 carbon atoms (for example, methanesulfonyl group, ethanesulfonyl group, and benzenesulfonyl group); sulphinyl groups having 1 to 20 carbon atoms, preferably having 1 to 10 carbon atoms, and more preferably 1 to 8 carbon atoms (for example, methanesulfonyl group, ethanesulfonyl group, and benzenesulfonyl group); unsubstituted or substituted amino groups having 1 to 20 carbon atoms, preferably having 1 to 12 carbon atoms, and more preferably having 1 to 8 carbon atoms (for example, amino group, methylamino group, dimethylamino group, benzylamino group, anilino group, diphenylamino group, 4-methylphenylamino group, 4-ethylphenylamino group, 3-n-propylphenylamino group, 4-n-propylphenylamino group, 3-n-butylphenylamino group, 4-n-butylphenylamino group, 3-n-pentylphenylamino group, 4-n-pentylphenylamino group, 3-trifluoromethylphenylamino group, 4-trifluoromethylphenylamino group, 2-pyridylamino group, 3-pyridylamino group, 2-thiazolylamino group, 2-oxazolylamino group, and N,N-methylphenylamino group); ammonium groups having 0 to 15 carbon atoms, preferably having 3 to 10 carbon atoms, and more preferably having 3 to 6 carbon atoms (for example, trimethylammonium group and triethylammonium group); hydrazino groups having 0 to 15 carbon atoms, preferably having 1 to 10 carbon atoms, and more preferably having 1 to 6 carbon atoms (for example, trimethylhydrazino group); ureide groups having 1 to 15 carbon atoms, preferably having 1 to 10 carbon atoms, and more preferably having 1 to 6 carbon atoms (for example ureide group, N,N-dimethylureide group); imide groups having 1 to 15 carbon atoms, preferably having 1 to 10 carbon atoms, and more preferably having 1 to 6 carbon atoms (for example, succinimide group); alkylthio groups having 1 to 20 carbon atoms, preferably having 1 to 12 carbon atoms, and more preferably having 1 to 8 carbon atoms (for example, methylthio group, ethylthio group, and propylthio group); arylthio groups having 6 to 80 carbon atoms, preferably having 6 to 40 carbon atoms, and more preferably having 6 to 30 carbon atoms (for example, phenylthio group, p-methylphenylthio group, p-chlorophenylthio group, 2-pyridylthio group, 1-naphthylthio group, 2-naphthylthio group, 4-propylcyclohexyl-4′-biphenylthio group, 4-butylcyclohexyl-4′-biphenylthio group, 4-pentylcyclohexyl-4′-biphenylthio group, and 4-propylphenyl-2-ethynyl-4′-biphenylthio group); heteroarylthio groups having 1 to 80 carbon atoms, preferably having 1 to 40 carbon atoms, and more preferably having 1 to 30 carbon atoms (for example, 2-pyridylthio group, 3-pyridylthio group, 4-pyridylthio group, 2-quinolylthio group, 2-furylthio group, and 2-pyrrolylthio group); alkoxycarbonyl groups having 2 to 20 carbon atoms, preferably having 2 to 12 carbon atoms, and more preferably 2 to 8 carbon atoms (for example, methoxycarbonyl group, ethoxycarbonyl group, and 2-benzyloxycarbonyl group); aryloxycarbonyl groups having 6 to 20 carbon atoms, preferably having 6 to 12 carbon atoms, and more preferably having 6 to 10 carbon atoms (for example, phenoxycarbonyl group), unsubstituted alkyl groups having 1 to 18 carbon atoms, preferably having 1 to 10 carbon atoms, and more preferably having 1 to 5 carbon atoms (for example, methyl group, ethyl group, propyl group, and butyl group); substituted alkyl groups having 1 to 18 carbon atoms, preferably having 1 to 10 carbon atoms, and more preferably having 1 to 5 carbon atoms {for example, hydroxymethyl group, trifluoromethyl group, benzyl group, carboxyethyl group, ethoxycarbonylmethyl group, acetylaminomethyl group; here, examples of the substituted alkyl group also include unsaturated hydrocarbon groups having 2 to 18 carbon atoms, preferably having 3 to 10 carbon atoms, and more preferably having 3 to 5 carbon atoms (for example, vinyl group, ethynyl group, 1-cyclohexenyl group, benzylidyne group, and benzylidene group)}; unsubstituted or substituted aryl groups having 6 to 20 carbon atoms, preferably having 6 to 15 carbon atoms, and more preferably having 6 to 10 carbon atoms (for example, phenyl group, naphthyl group, p-carboxyphenyl group, p-nitrophenyl group, 3,5-dichlorophenyl group, p-cyanophenyl group, m-fluorophenyl group, p-tolyl group, 4-propylcyclohexyl-4′-biphenyl group, 4-butylcyclohexyl-4′-biphenyl group, 4-pentylcyclohexyl-4′-biphenyl group, and 4-propylphenyl-2-ethynyl-4′-biphenyl group); and unsubstituted or substituted heteroaryl groups having 1 to 20 carbon atoms, preferably having 2 to 10 carbon atoms, and more preferably having 4 to 6 carbon atoms (for example, pyridyl group, 5-methylpyridyl group, thienyl group, furyl group, morpholino group, and tetrahydrofurfuryl group).

Each of these substituent groups V can also have a structure in which a benzene ring and a naphthalene ring are condensed. Further, each of these substituent groups V may be substituted by each of the substituent groups explained above in the substituent groups V.

Preferred examples of the substituent groups V include the above-mentioned alkyl groups, aryl groups, alkoxy groups, aryloxy groups, halogen atoms, amino groups, substituted amino groups, hydroxy groups, alkylthio groups, and arylthio groups. More preferred examples are the above-noted alkyl groups, aryl groups, and halogen atoms.

In the General Formula (1), Q¹ represents a divalent bound group. Preferred examples thereof are bound groups of atom groups composed of at least one atom selected from carbon atoms, nitrogen atoms, sulfur atoms, and oxygen atoms. Examples of the divalent bound group represented by Q¹ include divalent bound groups having 0 to 60 carbon atoms each composed of one or a combination of two or more selected from alkylene groups preferably having 1 to 20 carbon atoms and more preferably having 1 to 10 carbon atoms (for example, methylene group, ethylene group, propylene group, butylene group, pentylene group, and cyclohexyl-1,4-diyl group), alkenylene groups preferably having 2 to 20 carbon atoms and more preferably having 2 to 10 carbon atoms (for example, ethenylene group), alkynylene groups having 2 to 20 carbon atoms and more preferably having 2 to 10 carbon atoms (for example, ethynylene group), amide groups, ether groups, ester groups, sulfonamide groups, sulfonic ester groups, ureide groups, sulfonyl groups, sulphinyl groups, thioether groups, carbonyl groups, —NR— groups (here, R represents a hydrogen atom, an alkyl group or an aryl group; the alkyl group represented by R is preferably an alkyl group having 1 to 20 carbon atoms and more preferably having 1 to 10 carbon atoms, and the aryl group represented by R is preferably an aryl group having 6 to 14 carbon atoms and more preferably having 6 to 10 carbon atoms.), azo groups, azoxy groups, and heterocyclic divalent groups (heterocyclic divalent groups preferably having 2 to 20 carbon atoms and more preferably 4 to 10 carbon atoms, and examples thereof include piperazine-1,4-diyl group).

Preferred examples of the divalent bound group represented by Q¹ include alkylene group, alkenylene group, alkynylene group, ether group, thioether group, amide group, ester group, carbonyl group and combined groups thereof.

Q¹ may further have a substituent group, and examples of the substituent group include the above-mentioned substituent groups V.

In the General Formula (1), C¹ represents an alkyl group, a cycloalkyl group, an alkoxy group, an alkoxycarbonyl group, an acyl group or an acyloxy group. The alkyl group, cycloalkyl group, alkoxy group, alkoxycarbonyl group, acyl group or acyloxy group represented by C¹ include respective substituent groups substituted by any of the above-mentioned groups.

C¹ represents an alkyl group or a cycloalkyl group having 1 to 30 carbon atoms, preferably having 1 to 12 carbon atoms, and still more preferably having 1 to 8 carbon atoms (for example, methyl group, ethyl group, propyl group, butyl group, t-butyl group, i-butyl group, s-butyl group, pentyl group, t-pentyl group, hexyl group, heptyl group, octyl group, cyclohexyl group, 4-methylcyclohexyl group, 4-ethylcychohexyl group, 4-propylcyclohexyl group, 4-butylcyclohexyl group, 4-pentylcyclohexyl group, hydroxymethyl group, trifluoromethyl group, and benzyl group), an alkoxy group having 1 to 20 carbon atoms, preferably having 1 to 10 carbon atoms, and more preferably having 1 to 8 carbon atoms (for example, methoxy group, ethoxy group, 2-methoxyethoxy group, and 2-phenylethoxy group), an acyloxy group having 1 to 20 carbon atoms, preferably having 2 to 12 carbon atoms, and more preferably having 2 to 8 carbon atoms (for example, acetyloxy group, and benzoyloxy group), an acyl group having 1 to 30 carbon atoms, preferably having 1 to 12 carbon atoms, and more preferably having 1 to 8 carbon atoms (for example, acetyl group, formyl group, pivaloyl group, 2-chloroacetyl group, stearoyl group, benzoyl group, and p-n-octyloxyphenylcarbonyl group), or an alkoxycarbonyl group having 2 to 20 carbon atoms, preferably having 2 to 12 carbon atoms, and more preferably having 2 to 8 carbon atoms (for example, methoxycarbonyl group, ethoxycarbonyl group, and 2-benzyloxycarbonyl group).

Preferably, C¹ is an alkyl group or an alkoxy group, more preferably, C¹ is an ethyl group, a propyl group, a butyl group, a pentyl group, a hexyl group, or a trifluoromethoxy group.

C¹ may further have a substituent group, and examples of the substituent group include the above-mentioned substituent groups V.

Among the substituent groups V, the substituent group of alkyl group represented by C¹ is, for example, preferably a halogen atom, a cyano group, a hydroxy group, a carbamoyl group, an alkoxy group, an aryloxy group, an acyl group, an acyloxy group, an acylamino group, an amino group, an alkylthio group, an arylthio group, a heteroarylthio group, an alkoxycarbonyl group or an aryloxycarbonyl group.

Among the substituent groups V, the substituent group of cycloalkyl group represented by C¹ is, for example, preferably a halogen atom, a cyano group, a hydroxy group, a carbamoyl group, an alkoxy group, an aryloxy group, an acyl group, an acyloxy group, an acylamino group, an amino group, an alkylthio group, an arylthio group, a heteroarylthio group, an alkoxycarbonyl group, an aryloxycarbonyl group or an alkyl group.

Among the substituent groups V, the substituent group of alkoxy group represented by C¹ is, for example, preferably a halogen atom (particularly, fluorine atom), a cyano group, a hydroxy group, a carbamoyl group, an alkoxy group, an aryloxy group, an acyl group, an acyloxy group, an acylamino group, an amino group, an alkylthio group, an arylthio group, a heteroarylthio group, an alkoxycarbonyl group or an aryloxycarbonyl group.

Among the substituent groups V, the substituent group of alkoxycarbonyl group represented by C¹ is, for example, preferably a halogen atom, a cyano group, a hydroxy group, a carbamoyl group, an alkoxy group, an aryloxy group, an acyl group, an acyloxy group, an acylamino group, an amino group, an alkylthio group, an arylthio group, a heteroarylthio group, an alkoxycarbonyl group or an aryloxycarbonyl group.

Among the substituent groups V, the substituent group of acyl group represented by C¹ is, for example, preferably a halogen atom, a cyano group, a hydroxy group, a carbamoyl group, an alkoxy group, an aryloxy group, an acyl group, an acyloxy group, an acylamino group, an alkylthio group, an arylthio group, a heteroarylthio group, an alkoxycarbonyl group or an aryloxycarbonyl group.

Among the substituent groups V, the substituent group of acyloxy group represented by C¹ is, for example, preferably a halogen atom, a cyano group, a hydroxy group, a carbamoyl group, an alkoxy group, an aryloxy group, an acyl group, an acyloxy group, an acylamino group, an amino group, an alkylthio group, an arylthio group, a heteroarylthio group, an alkoxycarbonyl group or an aryloxycarbonyl group.

In the General Formula (1), “j” is an integer of 0 or 1, and is preferably 0 (zero).

“p”, “q” and “r” are respectively an integer of 0 to 5; “n” is an integer of 1 to 3; the total number of groups represented by B¹ and B², i.e., (p+r)×n, is an integer of 3 to 10, and more preferably an integer of 3 to 5.

When “p”, “q” or “r” is 2 or more, each of {(B¹)_{p-(Q}¹)_{q-(B}²)ᵣ} being 2 or more, may be the same to each other or different from each other, and when “n” is an integer of 2 or more, each of {(B¹)ₚ-(Q¹)_{q}-(B²)ᵣ} being 2 or more, may be the same to each other or different from each other.

Preferred combinations of “p”, “q”, “r”, and “n” are as follows:

(i) p=3, q=0, r=0, n=1
(ii) p=4, q=0, r=0, n=1
(iii) p=5, q=0, r=0, n=1
(iv) p=2, q=0, r=1, n=1
(v) p=2, q=1, r=1, n=1
(vi) p=1, q=1, r=2, n=1
(vii) p=3, q=1, r=1, n=1
(viii) p=2, q=0, r=2, n=1
(ix) p=1, q=1, r=1, n=2
(x) p=2, q=1, r=1, n=2

Of these combinations, particularly preferable combinations are (i) p=3, q=0, r=0, n=1; (iv) p=2, q=0, r=1, n=1; and (v) p=2, q=1, r=1, n=1.

Note that —{(B¹)ₚ-(Q¹)_{q}-(B²)ᵣ}n-C¹ preferably contains a partial structure exhibiting liquid crystallinity. For the “liquid crystal” mentioned in the present invention, any phases may be used, however, it is preferably a nematic liquid crystal, a smectic liquid crystal or a discotic liquid crystal, and is particularly preferably a nematic liquid crystal.

The following are specific examples of the —{(B¹)ₚ-(Q¹)_{q}-(B²)ᵣ}n-C¹, however, the specific examples thereof are not limited thereto. In the following chemical formulas, each of the wavy lines represents a binding site.

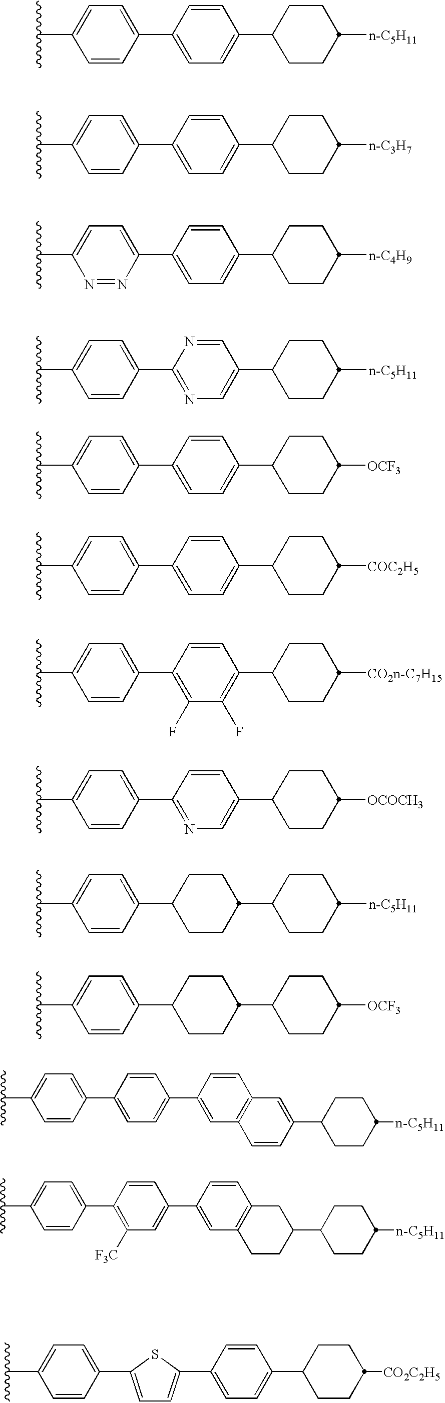

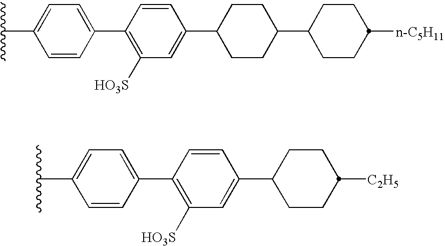

The dichroic pigment used in the present invention preferably has one or more substituent groups represented by —{(B¹)ₚ-(Q¹)_{q}-(B²)ᵣ}n-C¹, more preferably has 1 to 8 substituent groups represented by —{(B¹)ₚ-(Q¹)_{q}-(B²)ᵣ}n-C¹, still more preferably has 1 to 4 substituent groups represented by —{(B¹)ₚ-(Q¹)_{q}-(B²)ᵣ}n-C¹, and particularly preferably has 1 or 2 substituent groups represented by —{(B¹)ₚ-(Q¹)_{q}-(B²)ᵣ}n-C¹.

Preferable structures of the substituent group represented by General Formula (1) are the following combinations:

[1] A structure in which “Het” is a sulfur atom, B¹ represents an aryl group or a heteroaryl group, B² represents a cyclohexane-1,4-diyl group, C¹ represents an alkyl group, “j” is an integer of 1, “p” is an integer of 2, “q” is 0 (zero), “r” is an integer of 1, and “n” is an integer of 1.

[2] A structure in which “Het” is a sulfur atom, B¹ represents an aryl group or a heteroaryl group, B² represents a cyclohexane-1,4-diyl group, C¹ represents an alkyl group, “j” is an integer of 1, “p” is an integer of 1, “q” is 0 (zero), “r” is an integer of 2, and “n” is an integer of 1.

Particularly preferable structures of the substituent group represented by General Formula (1) are the following combinations:

[1] A structure represented by the following General Formula (a-1) in which “Het” is a sulfur atom, B¹ represents a 1,4-phenylene group, B² represents a trans-cyclohexyl group, C¹ represents an alkyl group (preferably represents a methyl group, an ethyl group, a propyl group, a butyl group, a pentyl group or a hexyl group), “j” is an integer of 1, “p” is an integer of 2, “q” is 0 (zero), “r” is an integer of 1, and “n” is an integer of 1.

[2] A structure represented by the following General Formula (a-2) in which “Het” is a sulfur atom, B¹ represents a 1,4-phenylene group, B² represents a trans-cyclohexane-1,4-diyl group, C¹ represents an alkyl group (preferably represents a methyl group, an ethyl group, a propyl group, a butyl group, a pentyl group or a hexyl group), “j” is an integer of 1, “p” is an integer of 1, “q” is 0 (zero), “r” is an integer of 2, and “n” is an integer of 1.

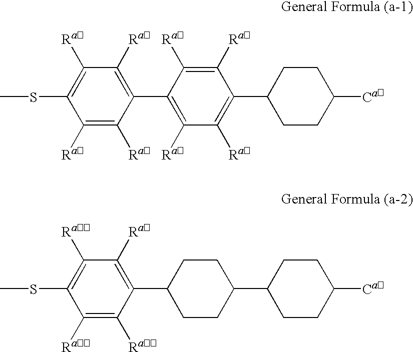

In General Formulas (a-1) and (a-2), R^{a1} to R^{a12} respectively represent a hydrogen atom or a substituent group. Examples of the substituent group include a substituent group selected from the above-mentioned substituent groups V.

Preferably, R^{a1} to R^{a12} respectively represent a hydrogen atom, a halogen atom (particularly, a fluorine atom), an alkyl group, an aryl group or an alkoxy group. Among the alkyl groups, aryl groups and alkoxy groups represented by any one of R^{a1} to R^{a12} preferable groups are the same as the alkyl groups, the aryl groups and the alkoxy groups described in the above-mentioned substituent groups V.

In General Formulas (a-1) and (a-2), C^{a1} to C^{a2} respectively represent an alkyl group, is preferably an alkyl group having 1 to 20 carbon atoms, and is more preferably an alkyl group having 1 to 10 carbon atoms. Particularly preferably, C^{a1} to C^{a2} respectively represent a methyl group, an ethyl group, a propyl group, a butyl group, a pentyl group, a hexyl group, a heptyl group, an octyl group or a nonyl group.

The azo pigment is not particularly limited and may be a monoazo pigment, a bisazo pigment, a trisazo pigment, a tetrakisazo pigment or a pentakisazo pigment, however, is preferably a monoazo pigment, a bisazo pigment, or a trisazo pigment.

The ring structure contained in the azo pigment may be, besides aromatic group (benzene ring, naphthalene ring, etc.), heterocyclic (quinoline ring, pyridine ring, thiazole ring, benzothiazole ring, oxazole ring, benzooxazole ring, imidazole ring, benzimidazole ring, pyrimidine ring, etc.).

A substituent group of the anthraquinone pigment preferably contain an oxygen atom, a sulfur atom or a nitrogen atom, and preferred examples thereof are an alkoxy group, an aryloxy group, an alkylthio group, an arylthio group, an alkylamino group and an arylamino group.

The number of the substituent groups is not particularly limited, however, di-substitution, tri-substitution, and tetrakis substitution are preferable. Di-substitution and tri-substitution are particularly preferable. The substituent group may be substituted at any sites, however, it is preferably 1,4-di-substituted structure, 1,5-di-substituted structure, 1,4,5-tri-substituted structure, 1,2, 4-tri-substituted structure, 1,2,5-tri-substituted structure, 1,2,4,5-tetra-substituted structure or 1,2,5,6-tetra-substituted structure.

For the anthraquinone pigment, it is more preferably a compound represented by the following General Formula (2). For the phenoxazone pigment, it is more preferably a compound represented by the following General Formula (3).

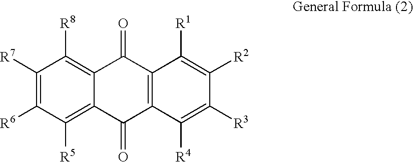

In General Formula (2), at least one of R¹, R², R³, R⁴, R⁵, R⁶, R⁷ and R⁸ is (Het)ⱼ-{(B¹)ₚ-(Q¹)_{q}-(B²)ᵣ}n-C¹, and the others are respectively a hydrogen atom or a substituent group.

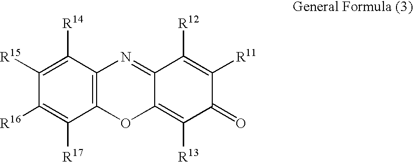

In General Formula (3), at least one of R¹¹, R¹², R¹³, R¹⁴, R¹⁵, R¹⁶ and R¹⁷ is -(Het)ⱼ-{(B¹)ₚ-(Q¹)_{q}-(B²)ᵣ}n-C¹, and the others are respectively a hydrogen atom or a substituent group.

Here, “Het”, B¹, B², Q¹, p, q, r, n, and C¹ are respectively the same as the Het, B¹, B², Q¹, p, q, r, n, and C¹ in the General Formula (1).

In General Formula (2), for the substituent groups represented by any one of R², R³, R⁴, R⁵, R⁶, R⁷ and R⁸, the above-mentioned substituent groups V are exemplified, however, the substituent groups are preferably arylthio groups having 6 to 80 carbon atoms, more preferably arylthio groups having 6 to 40 carbon atoms, and still more preferably arylthio groups having 6 to 30 carbon atoms (for example, phenylthio group, p-methylphenylthio group, p-chlorophenylthio group, 4-methylphenylthio group, 4-ethylphenylthio group, 4-n-propylphenylthio group, 2-n-butylphenylthio group, 3-n-butylphenylthio group, 4-n-butylphenylthio group, 2-t-butylphenylthio group, 3-t-butylphenylthio group, 4-t-butylphenylthio group, 3-n-pentylphenylthio group, 4-n-pentylphenylthio group, 4-amylpentylphenylthio group, 4-hexylphenylthio group, 4-heptylphenylthio group, 4-octylphenylthio group, 4-trifluoromethylphenylthio group, 3-trifluoromethylphenylthio group, 2-pyridilthio group, 1-naphthylthio group, 2-naphthylthio group, 4-propylcyclohexyl-4′-biphenylthio group, 4-butylcyclohexy1-4′-biphenylthio group, 4-pentylcyclohexyl-4′-biphenylthio group, and 4-propylphenyl-2-ethynyl-4′-biphenylthio group); heteroarylthio groups having 1 to 80 carbon atoms, preferably having 1 to 40 carbon atoms, and still more preferably having 1 to 30 carbon atoms (for example, 2-pyridilthio group, 3-pyridilthio group, 4-pyridilthio group, 2-quinolylthio group, 2-furylthio group, 2-pyrrolylthio group); unsubstituted or substituted alkylthio groups (for example, methylthio group, ethylthio group, butylthio group, and phenethylthio group); unsubstituted or substituted amino groups (for example, amino group, methylamino group, dimethylamino group, benzylamino group, anilino group, diphenylamino group, 4-methylphenylamino group, 4-ethylphenylamino group, 3-n-propylphenylamino group, 4-n-propylphenylamoino group, 3-n-butylphenylamino group, 4-n-butylphenylamino group, 3-n-pentylphenylamino group, 4-n-pentylphenylamino group, 3-trifluoromethylphenylamino group, 4-trifluoromethylphenylamino group, 2-pyridilamino group, 3-pyridilamino group, 2-thiazolylamino group, 2-oxazolylamino group, N,N-methylphenylamino group, N,N-ethylphenylamino group); halogen atom (for example, fluorine atom, and chlorine atom); unsubstituted or substituted alkyl group (for example, methyl group, and trifluoromethyl group); unsubstituted or substituted alkoxy group (for example, methoxy group, and trifluoromethoxy group); unsubstituted or substituted aryl group (for example, phenyl group); unsubstituted or substituted heteroaryl group (for example, 2-pyridil group); unsubstituted or substituted aryloxy group (for example, phenoxy group); and unsubstituted or substituted heteroaryloxy group (for example, 2-thienyloxy group).

Preferred examples of R²,

R³, R⁴, R⁵, R⁶, R⁷ and R⁸ include hydrogen atom, fluorine atom, chlorine atom, and unsubstituted or substituted arylthio group, alkylthio group, amino group, alkylamino group, arylamino group, alkyl group, aryl group, alkoxy group or aryloxy group. Particularly preferable examples thereof are hydrogen atom, fluorine atom, and unsubstituted or substituted arylthio group, alkylthio group, amino group, alkylamino group or arylamino group.

Further preferably, in General Formula (2), at least one of the R⁴, R⁵, and R⁸ is -(Het)ⱼ-{(B¹)ₚ-(Q¹)_{q}-(B²)ᵣ}n-C¹.

In General Formula (3), substituent groups represented by Ru, R¹², R¹³,

R¹⁴, R¹⁵, R¹⁶ or R¹⁷ are halogen atom, alkyl group, aryl group, alkylthio group, arylthio group, heterocyclic thio group, hydroxyl group, alkoxy group, aryloxy group, carbamoyl group, acyl group, aryloxy carbonyl group, alkoxy carbonyl group, and amide group. Particularly preferable examples thereof are hydrogen atom, halogen atom, alkyl group, arylthio group, and amide group.

Substituent groups represented by R¹⁶ are amino group (including alkylamino group and arylamino group), hydroxyl group, mercapto group, alkylthio group, arylthio group, alkoxy group or aryloxy group. Particularly preferable examples thereof are amino group.

The following are specific examples of dichroic pigments usable in the present invention, however, the examples thereof are not limited thereto.

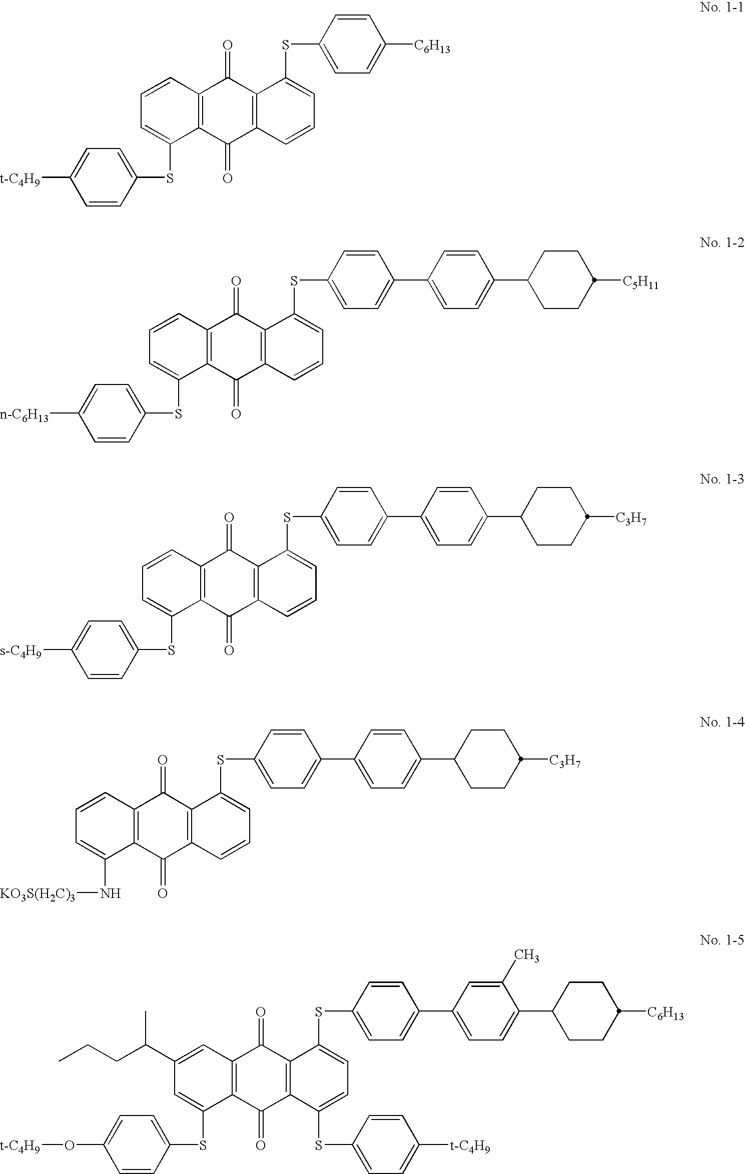

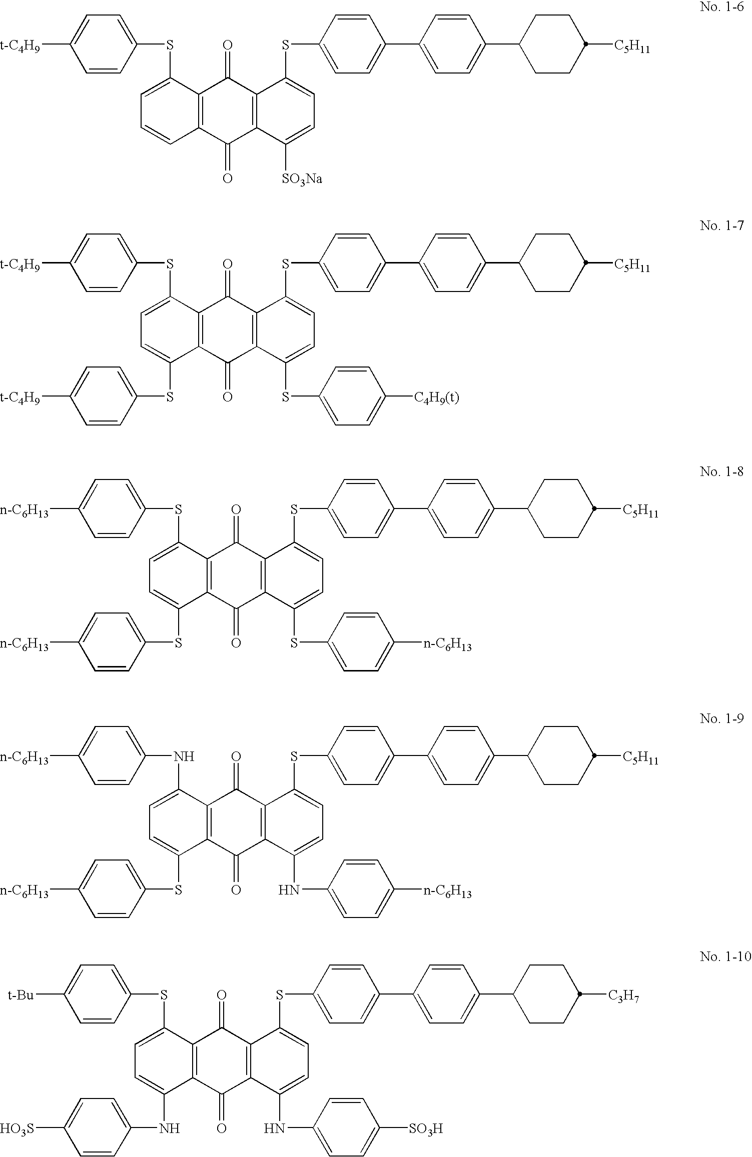

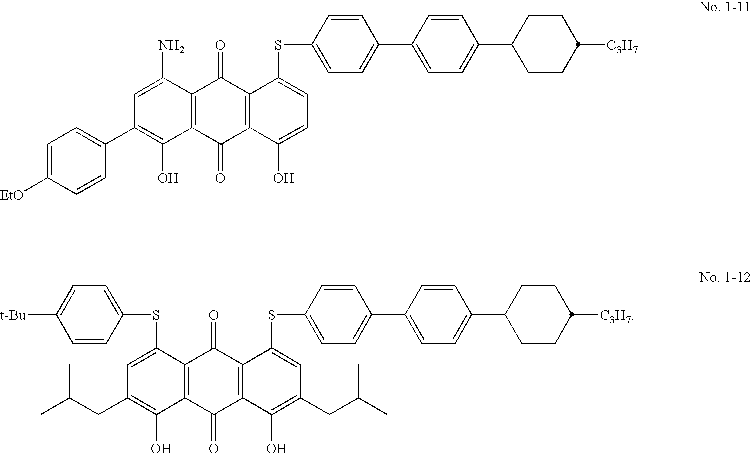

However, in the above structural formulas, “Et” represents an ethyl group, and “t-Bu” represents a tertiary butyl group.

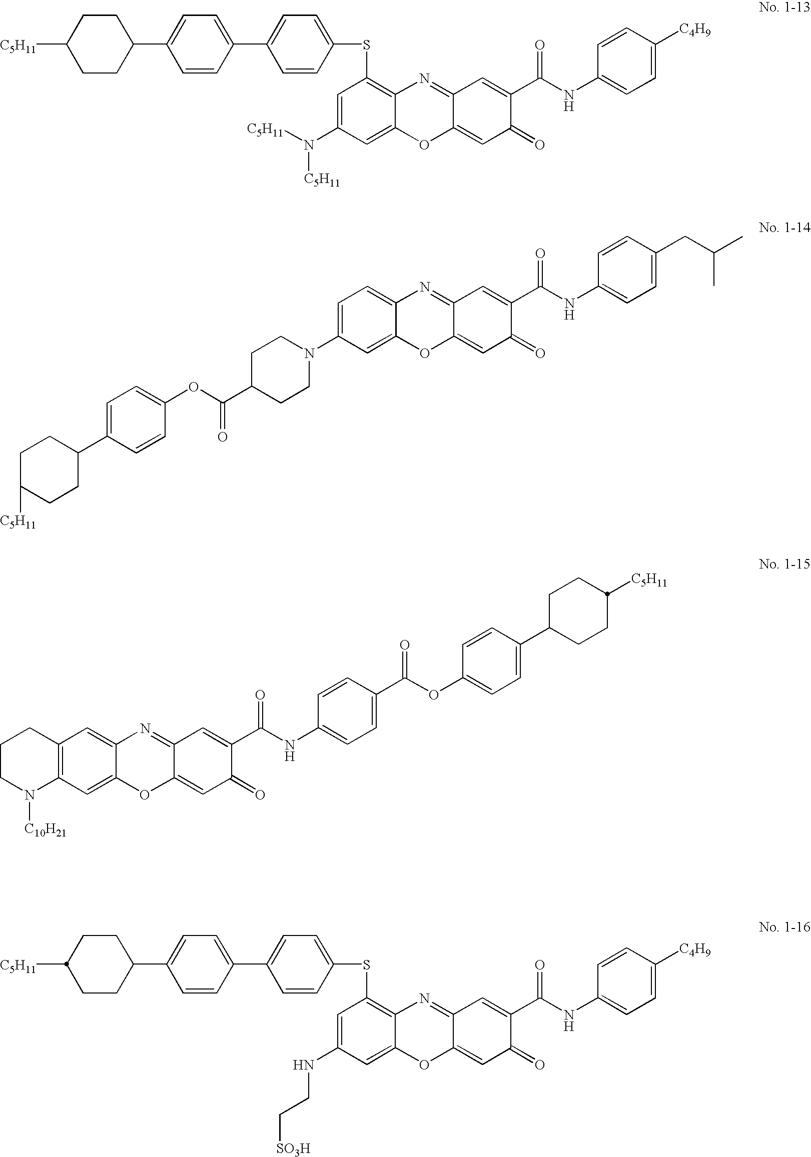

The following are specific examples of azo dichroic pigments usable in the present invention, however, the examples thereof are not limited thereto.

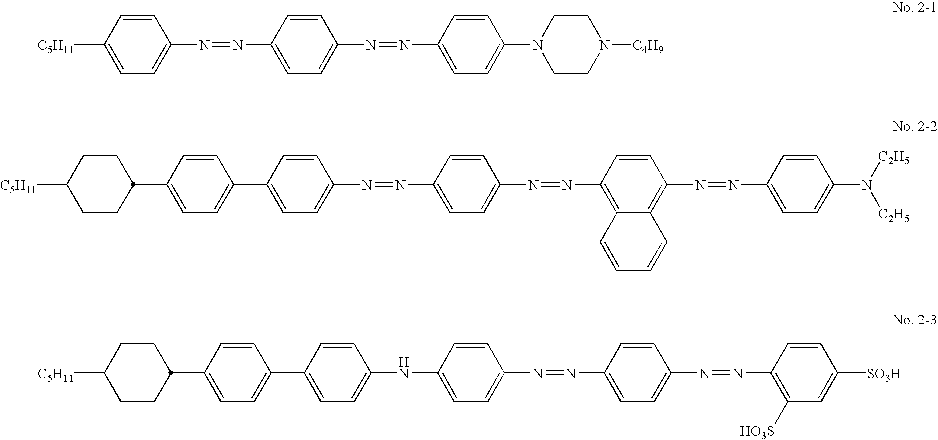

The following are specific examples of dioxazine dichroic pigments and merocyanine dichroic pigments usable in the present invention, however, the examples thereof are not limited thereto.

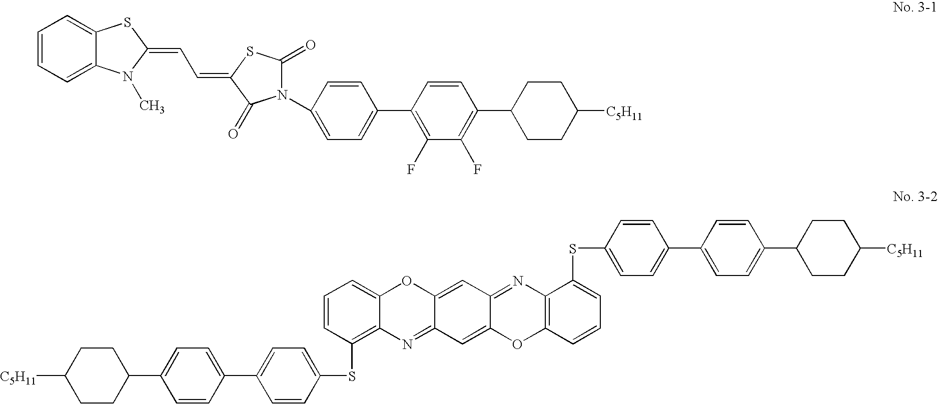

A dichroic pigment having a substituent group represented by General Formula (1) can be synthesized by a combination of known methods, for example, can be synthesized by the method described in Japanese Patent Application Laid-Open (JP-A) No. 2003-192664.

### —Anisotropic Metal Nano Particle—

The anisotropic metal nano particle is a rod-like metal fine particle in nano size of several nano-meters to 100 nm. The rod-like metal fine particle means a particle having an aspect ratio (major axis length/minor axis length) of 1.5 or more.

Such an anisotropic metal nano particle exhibits surface plasmon resonance and exhibits absorptivity at ultraviolet wavelength region to infrared wavelength region. For example, an anisotropic metal nano particle having a minor axis length of 1 nm to 50 nm, a major axis length of 10 nm to 1,000 nm and an aspect ratio of 1.5 or more allows for changing the absorption position thereof between the minor axis direction and the major axis direction, and thus a polarized film in which such an anisotropic metal nano particle is oriented in an oblique direction to the horizontal surface of the film is an anisotropically absorbing film.

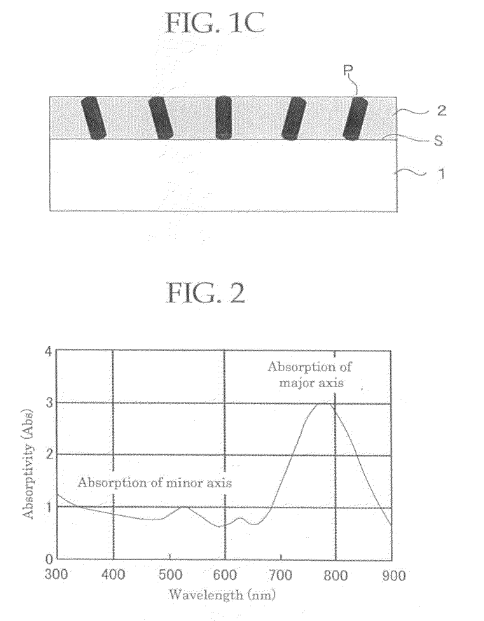

Here, FIG. 2 shows an absorption spectrum of an anisotropic metal nano particle having a minor axis length of 12.4 nm and a major axis length of 45.5 nm. Absorption of the minor axis of such an anisotropic metal nano particle resides near a wavelength of 530 nm and is red shifted. Absorption of the major axis of the anisotropic metal nano particle resides near a wavelength of 780 nm and is blue shifted.

Examples of metal type of the anisotropic metal nano particle include gold, silver, copper, platinum, palladium, rhodium, osmium, ruthenium, iridium, iron, tin, zinc, cobalt, nickel, chrome, titanium, tantalum, tungsten, indium, aluminum or alloys thereof. Of these, gold, silver, copper and aluminum are preferable, and gold and silver are particularly preferable.

Hereinafter, as a preferred example of anisotropic metal nano particle, a gold nano-rod will be explained.

### —Gold Nano-Rod—

Production method of the gold nano-rod is not particularly limited and may be suitably selected in accordance with the intended use, and (1) electrolytic method, (2) chemical reduction method and (3) photoreduction method are exemplified.

In the (1) electrolytic method [Y.-Y. Yu, S.-S. Chang. C.-L. Lee, C. R. C. Wang, J. Phys. Chem. B, 101,6661 (1997)], an aqueous solution containing a cationic surfactant is electrolyzed by passing a constant electric current through it, and gold cluster is eluted from an anodic metal plate to generate a gold nano rod. For the surfactant, a tetra ammonium salt having a structure in which four hydrophobic substituent groups are bound to a nitrogen atom is used, and a compound that does not form autonomous molecular aggregate such as tetradodecyl ammonium bromide (TDAB) is further added thereto. When a gold nano-rod is produced, the supply source of gold is a gold cluster eluted from an anodic gold plate, and no gold salt such as chlorauric acid is used. During electrolyzation, an anodic gold plate is irradiated with an ultrasonic wave, and a silver plate is immersed in the solution to accelerate the growth of the gold nano-rod.

In the electrolytic method, the length of a gold nano-rod to be produced can be controlled by changing the area of a silver plate to be immersed, separately to electrodes to be used. By controlling the length of a gold nano-rod, the position of an absorption band of near-infrared light region can be set in between around 700 nm to around 1,200 nm. When reaction conditions are kept constant, a gold nano-rod formed in a certain shape can be produced. However, because a surfactant solution to be used in electrolyzation a complicated system containing an excess amount of tetra ammonium salt, cyclohexane and acetone and there is an indefinite element such as irradiation of an ultrasonic wave, it is difficult to theoretically analyze a cause-effect relationship between the shape of gold nano-rod to be produced and various preparation conditions and to optimize the gold nano-rod preparation conditions. Further, in terms of electrolyzation characteristics, it is not easy to intrinsically scale up, and thus electrolytic method is not suited for preparation of a large amount of gold nano-rod.

In the (2) chemical reduction method [N. R. Jana, L. Gearheart, C. J. Murphy, J. Phys. Chem. B, 105, 4065 (2001)], a chlorauric acid is reduced using NaBH₄ to generate a gold nano particle. The gold nano particle is used as a “seed particle” and the “seed particle” is made grow up in the solution to thereby obtain a gold nano rod. The length of the gold nano-rod to be produced is determined depending on the quantitative ratio between the “seed particle” and the chlorauric acid to be added to the grown-up solution. The chemical reduction method allows for preparing a gold nano-rod having a longer length than that produced by the electrolytic method, and there has been reported a gold nano-rod having a length longer than 1,200 nm and an absorption peak in near-infrared light region.

However, the chemical reduction method needs to prepare a “seed particle” and two reaction tanks and to subject it to a growth reaction, Generation of a “seed particle” ends after several minutes, however, it is difficult to increase the concentration of the gold nano-rod to be produced. The concentration of generated gold nano-rod is one-tenth or less the concentration of a gold nano-rod generated by the (1) electrolytic method.

In the (3) photoreduction method [F. kim, J. H. Song, P. Yang, J. Am. Chem. Soc., 124, 14316 (2002)], a chlorauric acid is added to the substantially same solution as used in the (1) electrolytic method, and the chlorauric acid is reduced by irradiation of ultraviolet ray. For the ultraviolet ray irradiation, a low-pressure mercury lamp is used. The photoreduction method allows for generating a gold nano-rod without generating a seed particle and has a characteristic in that the shape of the gold nano-rod to be produced is uniformized. Further, the (1) electrolytic method needs fractionation of particles by centrifugal separation because a large amount of spherically shaped particles coexist, however, the photoreduction method needs no fractionation treatment because the method causes less amount of spherically shaped particles. The photoreduction method is excellent in reproductivity and enables to substantially surely obtain gold nano-rods in same size with constant operation.

### —Carbon Nanotube—

The carbon nanotube is an elongated tubular carbon of 1 nm to 1,000 nm in fiber diameter, 0.1 μm to 1,000 μm in length, and 100 to 10,000 in aspect ratio.

For the production method of the carbon nanotube, for example, there are arc discharge method, laser evaporation method, heat CVD method, and plasma CVD method known in the art. Carbon nanotubes obtainable from the arc discharge method or the laser evaporation method are classified into a single-layer carbon nanotube (SWNT: Single Wall Nanotube) formed with only one-layer of graphene sheet and a multi-layered carbon nanotube (MWNT: Maluti Wall Nanotube) formed with a plurality of graphene sheets.

In the meanwhile, in the heat CVD method or the plasma CVD method, mainly a multi wall nanotube can be produced. The single wall nanotube has a structure in which one graphene sheet is wrapped around a material in which carbon atoms are bound to each other in a hexagonal shape by the strongest bond called an SP2 bond.

The carbon nanotube (SWNT, MWNT) is a tubular material of 0.4 nm to 10 nm in diameter and 0.1 μm to several ten micro meters in length, having a structure one graphene sheet is or several graphene sheets are rolled in a cylindrical shape. It has a unique characteristic in that it becomes a metal or a semiconductor depending on in which direction the graphene sheet(s) are rolled. Such a carbon nanotube has characteristics that light absorption and emission easily occurs in the longitudinal direction thereof but rarely occurs in the radial direction thereof, and can be used as an anisotropically absorbing material and an anisotropic scattering material.

The content of the polarizer in the polarized film is preferably 0.1% by mass to 90.0% by mass and more preferably 1.0% by mass to 30.0% by mass. When the content is more than 0.1% by mass, sufficient polarization performance can be obtained. In the meanwhile, when the content of the polarizer in the polarized film is 90.0% by mass or less, a polarized film can be formed with no difficulty, and the transmittance of the polarized film can be maintained.

The polarized film contains, besides the polarizer, other components such as a dispersing agent, a solvent and a binder resin, according to the forming method of a polarized film (orientation method).

### —Production Method of Polarized Film—

The production method of a polarized film is not particularly limited as long as the major axis of a polarizer can be oriented in a perpendicular direction to the substrate surface (horizontal surface), and may be suitably selected in accordance with the intended use. Examples of the production method include (1) guest-host liquid crystal method and (2) anodic oxidation alumina method.

The (1) guest-host liquid crystal method is a method of forming a polarized film in which at least an ultraviolet curable liquid crystal compound and a polarized film coating solution containing a polarizer are applied over the surface of a substrate having an oriented film on the surface thereof, the applied surface is dried to form a coating layer and the coating layer is irradiated with ultraviolet ray in a state where the coating layer is heated to a temperature at which a liquid crystal phase occurs to thereby form a polarized film in which the major axis of the polarizer is oriented in a substantially perpendicular to the substrate surface.

### —Substrate—

The substrate is not particularly limited as to the shape, structure, size and the like, and may be suitably selected in accordance with the intended use. Examples of the shape of the substrate include a plate and a sheet. The substrate may be formed in a single-layer structure or a multi-layered structure and the structure can be suitably selected.

Material used for the substrate is not particularly limited, and both inorganic materials and organic materials can be suitably used.

Examples of the inorganic materials include glass, quartz and silicon. Examples of the organic materials include acetate resins such as triacetylcellulose (TAC); polyester resins, polyether sulfone resins, polysulfone resins, polycarbonate resins, polyamide resins, polyimide resins, polyolefin resins, acrylate resins, polynorbornene resins, cellulose resins, polyarylate resins, polystyrene resins, polyvinyl alcohol resins, polyvinyl chloride resins, polyvinylidene chloride resins, and polyacrylate resins. Each of these materials may be used alone or in combination with two or more.

The substrate may be a suitably synthesized substrate or a commercially available product may be used.

The thickness of the substrate is not particularly limited and may be suitably selected in accordance with the intended use, it is preferably 10 μm to 500 μm and more preferably 50 μm to 300 μm.

### —Oriented Film—

The oriented film is the one that is formed with a film of polyimide, polyamideimide, polyetherimide, polyvinyl alcohol etc. on the surface of the substrate.

The oriented film may be a film subjected to a photo-alignment treatment. In the photo-alignment, an anisotropy is generated on a surface of a photo-alignment film by irradiating photoactive molecules such as azobenzene polymer, polyvinyl cinnamate or the like with a linearly polarized beam or unpolarized light having a wavelength causing a photochemical reaction, an orientation of molecular major axis is generated on the outermost surface of the film by effect of incident light, and a driving force is formed which makes a liquid crystal contacting with molecules on the outermost surface oriented.

Examples of material of the photo-alignment film include, besides the above-mentioned materials, materials capable of generating an anisotropy on a film surface by any one of reactions of photoisomerization by irradiation of a linearly polarized beam having a wavelength causing a photochemical reaction of photoactive molecules, photodimerization, photocyclization, photocrosslinking, photodegradation, and photodegradation-bonding. For example, it is possible to use various photo-alignment film materials described in “Journal of the Liquid Crystal Society of Japan, Vol. 3 No. 1, p 3 (1999), by Masaki Hasegawa”, “Journal of the Liquid Crystal Society of Japan, Vol. 3 No. 4, p 262 (1999)” by Yasumasa Takeuchi” and the like.

When a liquid crystal is applied over the surface of an oriented film described above, the liquid crystal is oriented by using at least any of fine grooves on the oriented film surface and orientation of molecules on the outermost surface as a driving force.

The ultraviolet curable liquid crystal compound is not particularly limited and may be suitably selected in accordance with the intended use as long at it has a polymerizable group and can be hardened by irradiation of ultraviolet ray. For example, compounds represented by any one of the following structural formulas are preferably exemplified.

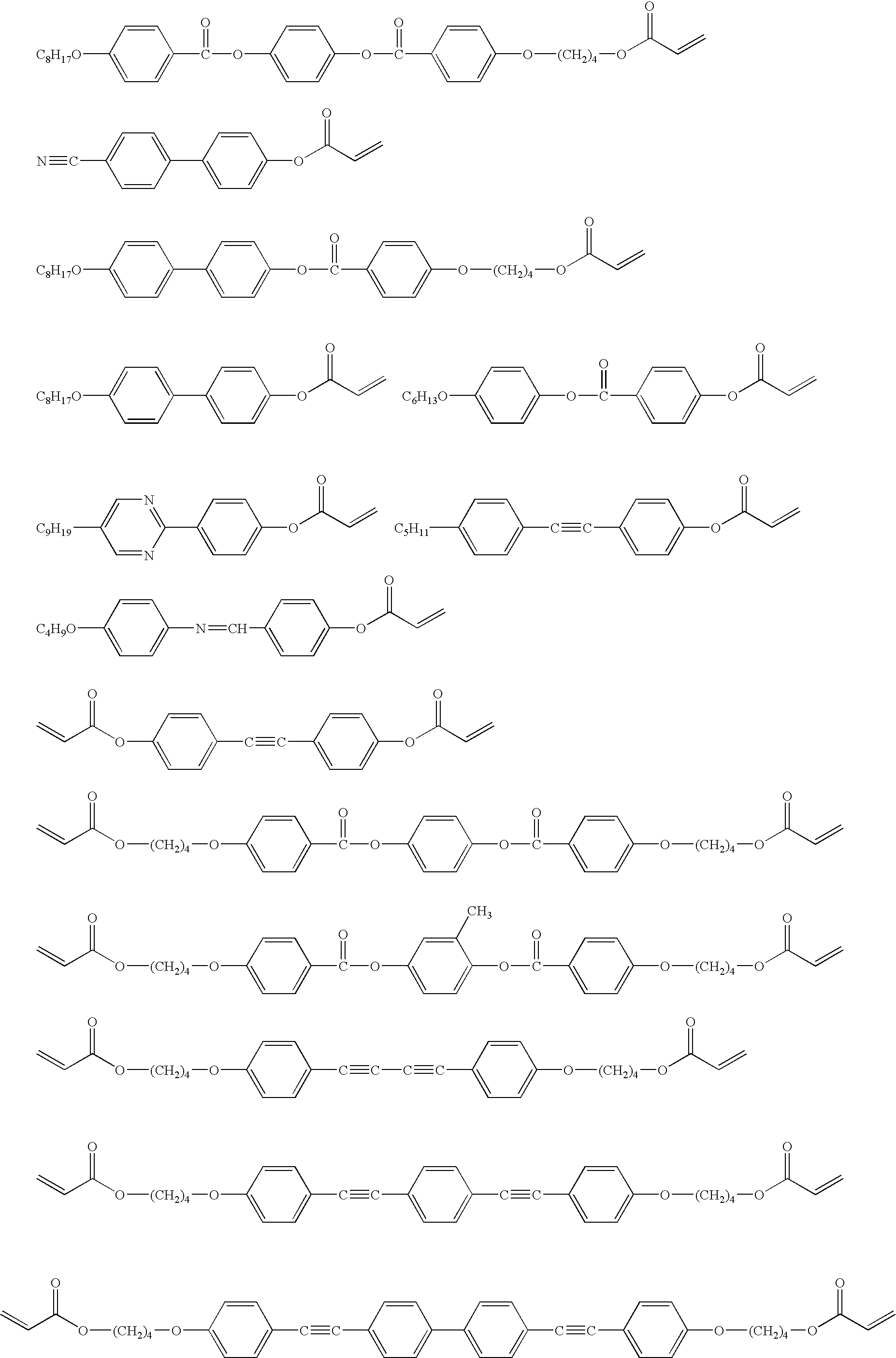

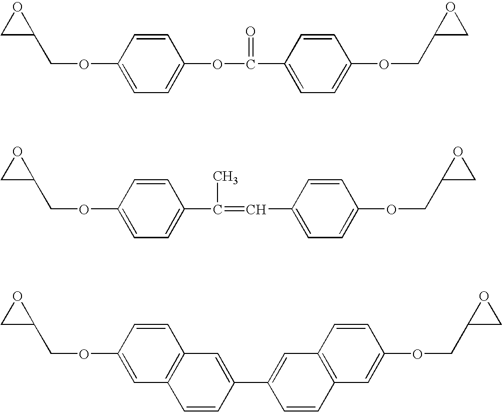

For the liquid crystal compound, commercially available products can be used. Examples of the commercially available products include brand name: PALIOCOLOR LC242 manufactured by BASF Corporation; brand name: E7 manufactured by Merck Japan; brand name: LC-SILICON-CC3767 manufactured by Wacker-Chemical; and brand name: L35, L42, L55, L59, L63, L79 and L83 manufactured by Takasago International Corporation.

The content of the liquid crystal compound is preferably 10% by mass to 90% by mass and more preferably 20% by mass to 80% by mass to the total solid content of the polarized film coating solution.

### —Polymer Surfactant—

The present invention is characterized in that the absorption axis of a polarizer is oriented substantially perpendicularly to a substrate surface. To this end, a liquid crystal layer serving as a medium must be oriented in a substantially perpendicular direction to the substrate surface. In some cases, a liquid crystal layer formed on a polarized film that has been formed on one surface of the substrate is substantially perpendicularly oriented from the oriented film side through to the air interface side by controlling the ends thereof so as to be hydrophobic, however, the orientation may be obliquely shifted in the air interface if left as it is. To avoid the problem, a polymer surfactant having high mutual interaction with a liquid crystal layer to be used is added to the liquid crystal layer, the polymer surfactant is uplifted on the air interface side during aging of orientation and makes the adjacent liquid crystal substantially perpendicularly oriented. As a result, the entire liquid crystal layer can be uniformly oriented in a substantially perpendicular direction from the oriented film surface side through to the air interface side.

For such a polymer surfactant, a nonionic surfactant is preferable, and a surfactant having a strong mutual interaction with a liquid crystal compound to be used may be selected from among commercially available polymer surfactants. For example, MEGAFAC F780F and the like manufactured by Dainippon Ink and Chemicals, Inc. are preferably exemplified.

The content of the polymer surfactant is preferably 0.01% by mass to 5.0% by mass and more preferably 0.05% by mass to 3.0% by mass to the total solid content of the polarized film coating solution.

### —Photopolymerization Initiator—

The polarized film coating solution preferably contains a photopolymerization initiator. The photopolymerization initiator is not particularly limited and may be suitably selected from among conventional photopolymerization initiators in accordance with the intended use. Examples thereof include p-methoxyphenyl-2,4-bis(trichloromethyl)-s-triazine, 2-(p-butoxystyryl)-5-trichloromethyl 1,3,4-oxadiazole, 9-phenylacrydine, 9,10-dimethylbenzphenazine, benzophenone/Michler's ketone, hexaarylbiimidazole/mercaptobenzimidazole, benzyldimethyl ketal, and thioxanthone/amine. Each of these photopolymerization initiators may be used alone or in combination with two or more.

For the photopolymerization initiator, commercially available products can be used. Examples of the commercially available products include brand name: IRGACURE 907, IRGACURE 369, IRGACURE 784 and IRGACURE 814; and brand name: LUCIRIN TPO manufactured by BASF Corporation.

The additive amount of the photopolymerization initiator is preferably 0.1% by mass to 20% by mass and more preferably 0.5% by mass to 5% by mass to the total solid content of the polarized film coating solution.

The polarized film coating solution can be prepared, for example, by dissolving or dispersing an ultraviolet curable liquid crystal compound, a polarizer and other components selected in accordance with necessity in a solvent.

The solvent is not particularly limited and may be suitably selected in accordance with the intended use. Examples thereof include halogenated hydrocarbons such as chloroform, dichloromethane, carbon tetrachloride, dichloroethane, tetrachloroethane, methylene chloride, trichloroethylene, tetrachloroethylene, chlorobenzene, and orthodichlorobenzene; phenols such as phenol, p-chlorophenol, o-chlorophenol, m-cresol, o-cresol, and p-cresol; aromatic hydrocarbons such as benzene, toluene, xylene, methoxybenzene, and 1,2-dimethoxybenzene; ketone solvents such as acetone, methylethylketone (MEK), methylisobutylketone, cyclohexanone, cyclopentanone, 2-pyrrolidone, and N-methyl-2-pyrrolidone; ester solvents such as ethyl acetate and butyl acetate; alcohol solvents such as t-butyl alcohol, glycerine, ethylene glycol, triethylene glycol, ethylene glycol monomethylether, diethylene glycol dimethylether, propylene glycol, dipropylene glycol, and 2-methyl-2,4-pentandiol; amide solvents such as dimethyl formamide and dimethylacetoamide; nitrile solvents such as acetonitrile and butylonitrile; ether solvents such as diethyl ether, dibutyl ether, tetrahydrofuran, and dioxane; and carbon disulfide, ethylcellosolve and butyl cellosolve. Each of these solvents may be used alone or in combination with two or more.

After the polarized film coating solution is applied over the surface of a substrate with an oriented film formed thereon and dried to form a coating layer, in order to fix the orientation condition of the polarizer, the coating layer is irradiated with ultraviolet ray in a state where the coating layer is heated to a temperature at which a liquid crystal phase occurs. With this treatment, it is possible to form a polarized film in which the absorption axis of the polarizer is oriented in a substantially perpendicular direction to the substrate surface (horizontal surface).

For the coating method, for example, spin-coating method, casting method, roller coating method, flow coating method, printing method, dip coating method, flow casting method, bar coating method and gravure coating method are exemplified.

Conditions for the ultraviolet ray irradiation are not particularly limited and may be suitably selected in accordance with the intended use. For example, the wavelength of an ultraviolet ray used for the irradiation is preferably 160 nm to 380 nm and more preferably 250 nm to 380 nm. The irradiation time is preferably 0.1 seconds to 600 seconds and more preferably 0.3 seconds to 300 seconds, for example. The heating condition is not particularly limited and may be suitably selected in accordance with the intended use, however, the heating temperature is preferably 60° C. to 120° C.

For a light source of the ultraviolet ray, for example, low-pressure mercury lamps (sterilized lamp, fluorescent chemical lamp, and black light), high-pressure electric discharge lamps (high-pressure mercury lamp, and metal halide lamp) and short-arc electric discharge lamps (ultra high-pressure mercury lamp, xenon lamp, and mercury xenon lamp) are exemplified.

The (2) anodic oxidation alumina method is a method of forming a polarized film in which aluminum is deposited on a surface of a substrate with a conductive film formed on the surface to form an aluminum deposition layer, the aluminum deposition layer is anodized to form nanoholes thereon, a metal is electroformed in the nanoholes to form a metal nano-rod having an aspect ratio of 1.5 or more to thereby form a polarized film in which the absorption axis of the metal nano-rod is substantially perpendicularly oriented to the substrate surface.

The substrate is not particularly limited as long as it is transparent, and may be suitably selected in accordance with the intended use. The same materials as those used in the (1) guest-host liquid crystal method can be used.

### —Conductive Film—

Material used for the conductive film is not particularly limited as long as it is transparent and electricity-conducting, and may be suitably selected in accordance with the intended use. Examples thereof include indium tin oxide (ITO), tin oxide (NESA), fluorine-doped tin oxide (FTO), indium oxide, zinc oxide, platinum, gold, silver, rhodium, copper, chrome, and carbon. Of these, fluorine-doped tin oxide (FTO) and indium tin oxide (ITO) are preferable in terms that they respectively have a low surface resistivity and a high light transmittance and are respectively excellent in heat resistance and chemically stable.

The conductive film can be formed by a gas phase method (for example, vacuum evaporation method, sputtering method, ion-plating method, and plasma CVD method).

The surface resistivity of the conductive film is preferably 100 Ω/cm² or less and more preferably 10 Ω/cm² or less.

The thickness of the conductive film is not particularly limited and may be suitably selected in accordance with the intended use. For example, it is preferably 1 nm to 500 nm and more preferably 5 nm to 200 nm.

### —Aluminum Deposition Layer—

The forming method of the aluminum deposition layer is not particularly limited, and the aluminum deposition layer can be formed according to a conventional method. For example, vapor deposition method and sputtering method are exemplified. Forming conditions of the aluminum deposition layer are not particularly limited and may be suitably adjusted in accordance with the intended use.

Specifically, when an aluminum film deposited of about 100 nm in thickness is used as a positive electrode, a suitable metal substrate is used as a negative electrode and the aluminum film and the metal substrate are oxidized in 0.5 mol/L of an oxalic-acid aqueous solution, a nano porous alumina film can be formed, and then the nano porous alumina film is washed, dried and electroformed, thereby forming a metal nano-rod into nanoholes of the alumina film.

The thickness of the aluminum deposition layer is not particularly limited and may be suitably adjusted in accordance with the intended use. For example, it is preferably 500 nm or less and more preferably 5 nm to 200 nm.

### —Anodic Oxidation Treatment—

The anodic oxidation treatment can be carried out by electrolytically etching an electrode that makes contact with the aluminum deposition layer as a positive electrode in an aqueous solution such as sulfuric acid, phosphoric acid, oxalic acid and the like.

The type, concentration, temperature, time and the like of an electrolytic solution used in the anodic oxidation treatment are not particularly limited and may be suitably adjusted according to the number of nanoholes to be formed, the size, the aspect ratio and the like of the nanoholes. For example, when the space (pitch) of the adjacent nanohole rows is 150 nm to 500 nm, for the type of the electrolytic solution, a diluted phosphoric acid solution is preferably exemplified; when the space of the adjacent nanohole rows is 80 nm to 200 nm, a diluted oxalic acid solution is preferably exemplified; and when the space of the adjacent nanohole rows is 10 nm to 150 nm, a diluted sulfuric acid solution is preferably exemplified. In any of the cases, the aspect ratio of the nono-holes can be controlled by immersing the substrate formed with the aluminum deposition layer on the surface thereof in a phosphoric acid solution after the anodic oxidation treatment and increasing the diameter of the nanoholes.

The nanoholes may be formed as pores by puncturing holes through an aluminum deposition layer or may be formed as dimples without puncturing holes through the aluminum deposition layer.

The array of the nanoholes is not particularly limited and may be suitably selected in accordance with the intended use. For example, it is preferable that the nanoholes be arrayed in parallel in one direction.

The space of the adjacent nanoholes (rows) is not particularly limited and may be suitably selected in accordance with the intended use, however, it is preferably 5 nm to 500 nm and more preferably 10 nm to 200 nm.

The aperture diameter of the nanoholes is not particularly limited and may be suitably adjusted in accordance with the intended use, however, it is preferably 1 nm to 50 nm and more preferably 5 nm to 30 nm.

The depth of the nanoholes is not particularly limited and may be suitably adjusted in accordance with the intended use, however, it is preferably 10 nm to 1,000 nm and more preferably 10 nm to 100 nm.

The aspect ratio (depth/aperture diameter) of the depth and the aperture diameter of the nanoholes is not particularly limited and may be suitably selected in accordance with the intended use, however, it is preferably 1.5 or more and more preferably 3 to 15.

Next, by electroforming the metal in the nanoholes, a metal nano-rod can be formed. The absorption axis of the obtained metal nano-rod is oriented in a substantially perpendicular direction to the horizontal reference surface of the film.

### <Phase Difference Film>

For the phase difference film, a half-wavelength plate is preferable.

The half-wavelength plate is not particularly limited and may be suitably selected in accordance with the intended use. For example, a drawn polycarbonate film, a drawn norbornene polymer film, a transparent film that is oriented by adding an inorganic particle having a birefringence property like strontium carbonate, and a thin film formed by obliquely depositing an inorganic dielectric material on a substrate are exemplified.

Examples of existing technologies include (1) a phase difference plate in which a birefringent film having a large retardation value and a birefringent film having a small retardation value are multilayered so that the optic axes thereof are mutually orthogonal, which is described in Japanese Patent Application Laid-Open (JP-A) Nos. 5-27118 and 5-027119; (2) a phase difference plate that enables to obtain a quarter-wavelength in a wide wavelength region by laminating a polymer film having a quarter wavelength at a specific wavelength and another polymer film composed of the same material as that used as the above-mentioned polymer film and having a half-wavelength at the same specific wavelength, which is described in Japanese Patent Application Laid-Open (JP-A) No. 10-68816; (3) a phase difference plate that allows for obtaining a quarter wavelength at a wide wavelength region by laminating two sheets of polymer films, which is described in Japanese Patent Application Laid-Open (JP-A) No. 10-90521; (4) a phase difference plate that allows for obtaining a quarter wavelength in a wide wavelength region by using a modified polycarbonate film, which is described in International Publication No. WO/00/26705; and (5) a phase difference plate that allows for obtaining a quarter wavelength in a wide wavelength region by using a cellulose acetate film, which is described in International Publication No. WO/00/65384.

Which to choose a half-wavelength plate or a quarter-wavelength plate can be determined by adjusting the drawing magnification ratio and the film thickness to make the film have a desired birefringence value.

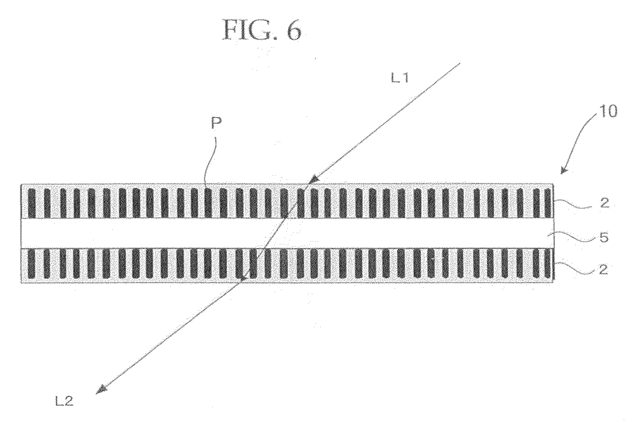

Here, in an optical film 10 of the present invention, as shown in FIG. 6, a half-wavelength plate 5 is inserted in between two polarized films 2, 2 each containing a perpendicularly oriented polarizer. Outside light L1 enters into the optical film 10 from an oblique direction (incident angle θ). First, light P1 having a wave surface in a plane perpendicular to a paper surface including the light path of the incident light beam is absorbed by a perpendicular polarizer of the first polarized film 2, converted into a polarization component S1 to be left, the polarization component S1 goes on and passes through the half-wavelength plate 5 to thereby be converted into a polarized light P1 that is perpendicular to the polarization component S1. The converted polarized light P1 passes obliquely through the second polarized film including a perpendicular polarizer, thereby the light intensity is drastically reduced to become a faint light L2. Depending on the uses, an accurate retardation rate of the half-wavelength plate and the optical axis lamination angle are determined depending on setting L2 to be the minimum optical intensity what degrees of the incident angle θ is, and thus the design of the half-wavelength plate greatly differs depending on the uses.

The optical film of the present invention enables to drastically reduce light intrusion into indoor rooms from outside light by placing the optical film at the front of a plasma display or a liquid crystal display to thereby improve brightness contrast in the room. When the optical film of the present invention is used as building glass such as windowpane as described hereinafter, it allows for preventing increases in room temperature and exhibiting an excellent partition effect that indoor rooms can be seen from the front view but cannot be seen from oblique angles because the indoors are seen as darkness.

### (Glass)

The glass used in the present invention has a substrate, an optical film, and an antireflection film and further has other layers in accordance with necessity.

### <Substrate>

For the substrate, glass (namely a glass substrate) is the most suitable. This is because glass has the most reliable track records in that it has 12-year endurance, which is the rough operating life of vehicles, even under environments where it is exposed to wind and rain and it does not disturb the polarization.

However, recently, plastics are provided even in polymer plate products which have high-durability and high-isotropy and are rarely disturb polarization, like norbornene polymers. Other materials are also usable for the substrate.

### —Substrate Glass—

The substrate glass is not particularly limited and may be suitably selected in accordance with the intended use. Examples thereof include single-layer glass, laminated glass, reinforced laminated glass, multi-layered glass, reinforced multi-layered glass, and laminated multi-layered glass are exemplified.

Examples of the type of plate glass constituting such a substrate glass include transparent plate glass, template glass, wire-included plate glass, line-included plate glass, reinforced plate glass, heat reflecting glass, heat absorbing glass, Low-E plate glass, and other various plate glasses.

The substrate glass may be a transparent colorless glass or a transparent color glass as long as it is a transparent glass.

The thickness of the substrate glass is not particularly limited and may be suitably selected in accordance with the intended use, however, it is preferably 2 mm to 20 mm and more preferably 4 mm to 10 mm.

### —Laminated Glass—

The laminated glass is formed in a unit structure in which an intermediate layer intermediates in between two sheets of plate glasses. Such a laminated glass is widely used as front glass of vehicles such as automobile and as windowpane such as for buildings because it is secure and broken pieces of glass do not fly apart even when affected by external impact. In a case of laminated glass for automobile, fairly thin laminated glasses have become used for the sake of weight saving, the thickness of one sheet of glass is 1 mm to 3 mm, and two sheets of the glasses are laminated via an adhesive layer of 0.3 mm to 1 mm in thickness, thereby forming a laminated glass of about 3 mm to 6 mm in total thickness.

The intermediate layer preferably contain the optical film of the present invention.

The two plate glasses may be suitably selected from among the above-mentioned various plate glasses in accordance with the intended use.

Examples of thermo plastic resins to be used for the intermediate layer include polyvinyl acetal resins, polyvinyl alcohol resins, polyvinyl chloride resins, saturated polyester resins, polyurethane resins, and ethylene-vinyl acetate copolymers. Of these thermoplastic resins, polyvinyl acetal resin is particularly preferable because it allows for obtaining an intermediate layer that is excellent in a balance of various properties such as transparency, weather resistance, strength and bonding force.

The polyvinyl acetal resin is not particularly limited and may be suitably selected in accordance with the intended use. Examples thereof include polyvinyl formal resins that can be obtained by reacting polyvinyl alcohol (hereinafter occasionally abbreviated as PVA) with formaldehyde; narrowly defined polyvinyl acetal resins that can be obtained by reacting PVA with acetaldehyde; and polyvinyl butyral resins that can be obtained by reacting PVA with n-butylaldehyde.

The PVA used for synthesis of the polyvinyl acetal resin is not particularly limited and may be suitably selected in accordance with the intended use, however, a PVA having an average polymerization degree of 200 to 5,000 is preferably used, and a PVA having an average polymerization degree of 500 to 3,000 is more preferably used. When the average polymerization degree is less than 200, the strength of an intermediate layer formed using an obtainable polyvinyl acetal resin may be excessively weak. When the average polymerization degree is more than 5,000, there may be troubles when an obtainable polyvinyl acetal resin is formed.

The polyvinyl acetal resin is not particularly limited and may be suitably selected in accordance with the intended use, however, a polyvinyl acetal resin having an acetalization degree of 40 mol % to 85 mol % is preferably used, and a polyvinyl acetal resin having an acetalization degree of 50 mol % to 75 mol % is more preferably used. It may be difficult to synthesize a polyvinyl acetal resin having an acetalization degree less than 40 mol % or more than 85 mol % because of its reaction mechanism. The acetalization degree can be measured according to JIS K6728.

To the intermediate layer, besides the thermoplastic resin, a plasticizer, a pigment, an adhesion adjustor, a coupling agent, a surfactant, an antioxidant, a thermal stabilizer, a light stabilizer, an ultraviolet absorbent, an infrared absorbent and the like can be added.

The forming method of the intermediate layer is not particularly limited and may be suitably selected in accordance with the intended use. For example, a method is exemplified in which a composition containing a thermoplastic resin and other components is uniformly kneaded and the kneaded product is formed into a sheet by a conventional method such as extrusion method, calendering method, pressing method, casting method and inflation method.

The thickness of the intermediate layer is not particularly limited and may be suitably selected in accordance with the intended use, however, it is preferably 0.3 mm to 1.6 mm.

In the present invention, from the perspective of productivity and durability, it is preferable that the intermediate layer contain the optical film of the present invention. When the intermediate layer is the optical film of the present invention, the intermediate layer is the same as the optical film except that the intermediate layer contains a polarizer and the polarizer is oriented in a substantially horizontal direction. Note that the optical film can also be formed on only one surface of a laminated glass.

The production method of the laminated glass is not particularly limited and may be suitably selected in accordance with the intended use. For example, the optical film of the present invention is sandwiched in between two transparent glass plates using an intermediate film, the laminated glass structure is put in a vacuum bag such as a rubber bag, the vacuum bag is connected to an exhaust system, the laminated glass structure is preliminarily bonded at a temperature of 70° C. to 110° C. while reducing the pressure and vacuuming or degassing so that the pressure in the vacuum bag is set as a depressurization degree of about −65 kPa to −100 kPa, then the preliminarily bonded laminated glass structure is put in an autoclave, heated at a temperature of 120° C. to 150° C. and pressurized under a pressure of 0.98 MPa to 1.47 MPa to actually bond it, thereby a desired laminated glass can be obtained.

For other layers in the glass, an antireflection film, hard-coat layer, a front scattering layer, a primer layer, an antistatic layer, an undercoat layer, a protective layer and the like may be formed in accordance with necessity.

### <Antireflection Film>

When the glass of the present invention is placed so that sunlight is incident from one surface of the substrate, the glass preferably has an antireflection film on at least the outermost surface of the substrate on which sunlight is not incident, i.e., on at least the outermost surface of the opposite surface from the one surface of the substrate. When the glass of the present invention is used as building glass or front glass of vehicle, it is more preferable that the glass have the optical film on a surface of the substrate on which sunlight is not incident (the internal surface of the vehicle) and has an antireflection film on the optical film.

The antireflection film is not particularly limited as long as it has sufficient durability and heat resistance in practical use and is capable of suppressing the reflectance to 5% or less, and may be suitably selected in accordance with the intended use. Examples thereof include (1) a film with fine convexoconcaves formed on the surface thereof, (2) a two-layered film structure using a combination of a film having a high refractive index and a film having a low refractive index, and (3) a three-layered film structure in which a film having a high refractive index, a film having a medium refractive index and a film having a low refractive index are sequentially formed in a laminate structure. Of these, the film (2) and the film (3) are particularly preferable.

Each of these antireflection films may be directly formed on a substrate surface by sol-gel method, sputtering method, deposition method, CVD method or the like. Further, each of these antireflection films may be formed by forming an antireflection film on a transparent substrate by dip coating method, air-knife coating method, curtain coating method, roller coating method, wire bar coating method, gravure coating method, micro-gravure coating method or extrusion coating method and making the formed antireflection film adhered on or bonded to the substrate surface.

The antireflection film preferably has at least a layer structure in which at least one layer of a high-refractive index layer that has a higher refractive index than that of a low-refractive index layer and the low-refractive index layer (the outermost layer) are formed in this order on a transparent substrate. When two layers of refractive index layers each having a higher refractive index than that of the low-refractive index layer are formed, a layer structure is preferable in which a medium refractive index layer, a high-refractive index layer and a low-refractive index layer (the outermost surface layer) are formed in this order on a transparent substrate. An antireflection film having such a layer structure is designed so as to have refractive indexes satisfying the relation of “a refractive index of a high-refractive index layer> a refractive index of a medium refractive index layer> a refractive index of a transparent substrate> a refractive index of a low-refractive index layer”. Note that the respective refractive indexes are relative indexes.

### —Transparent Substrate—

For the transparent substrate, it is preferable to use a plastic film. Examples of material of the plastic film include cellulose acylates, polycarbonates, polyesters (for example, polyethylene terephthalate, polyethylene naphthalate, etc.), polystyrenes, polyolefins, polysulfones, polyether sulfones, polyarylates, polyetherimides, polymethyl methacrylates, and polyether ketones.

### —High-Refractive Index Layer and Medium Refractive Index Layer—

The layer having a high-refractive index in the antireflection layer is preferably composed of a curable film containing an inorganic fine particle having a high-refractive index with the average particle diameter of 100 nm or less and a matrix binder.

For the inorganic fine particle having a high-refractive index, an inorganic compound having a refractive index of 1.65 or more is exemplified, and an inorganic compound having a refractive index of 1.9 or more is preferably exemplified. Examples thereof include oxides of Ti, Zn, Sb, Sn, Zr, Ce, Ta, La, In, Al and the like or composite oxides containing these metal atoms. Of these, an inorganic fine particle (hereinafter, may be referred to as “specific oxide”) that mainly contains titanium dioxide containing at least one element selected from Co, Zr and Al is preferable, and a particularly preferable element is Co.

The total content of Co, Al and Zr to the content of Ti is preferably 0.05% by mass to 30% by mass, more preferably 0.1% by mass to 10% by mass, still more preferably 0.2% by mass to 7% by mass, particularly preferably 0.3% by mass to 5% by mass, and the most preferably 0.5% by mass to 3% by mass.

Co, Al and Zr exist inside or on the surface of the inorganic fine particle mainly containing titanium dioxide. It is more preferable that Co, Al and Zr exist inside the inorganic fine particle mainly containing titanium dioxide, and it is the most preferable that Co, All and Zr exist inside and on the surface of the inorganic fine particle mainly containing titanium dioxide. These specific metal elements may exist as oxides.

Further, as another preferable inorganic fine particle, an inorganic fine particle is exemplified which is a particle of a composite oxide composed of a titanium element and at least one metal element (hereinafter, occasionally abbreviated as “Met”) selected from metal elements that will have a refractive index of 1.95 or more and the composite oxide is doped with at least one metal ion selected from Co ion, Zr ion and Al ion (may be referred to as “specific composite oxide”).

Here, examples of the metal element of metal oxide that will have a refractive index of 1.95 or more in the composite oxide include Ta, Zr, In, Nd, Sb, Sn and Bi. Of these, Ta, Zr, Sn and Bi are particularly preferable.

For the content of the metal ion doped into the composite oxide, it is preferable that the metal ion be contained in a range not exceeding 25% by mass to the total metal content [Ti and Met] constituting the composite oxide, from the viewpoint of maintaining refractive indexes. The content of the metal ion to the total metal content constituting the composite oxide is more preferably 0.05% by mass to 10% by mass, still more preferably 0.1% by mass to 5% by mass, and particularly preferably 0.3% by mass to 3% by mass.

The doped metal ion may exist as any of a metal ion or a metal atom and preferably exists in an appropriate amount from the surface of the composite oxide through the inside thereof. It is more preferable that the doped metal ion exist on the surface of the composite oxide and inside the composite oxide.

Examples of a method of producing an ultrafine particle as above include a method in which the particle surface is treated with a surface finishing agent; a method of making a core shell structure in which a particle having a high-refractive index is used as the core, and a method of using a specific dispersing agent in combination.

Examples of the surface finishing agent used in the method of treating the particle surface therewith include the anionic compounds or organic metal coupling agents described in Japanese Patent Application Laid-Open (JP-A) Nos. 11-295503, 11-153703 and 2000-9908.

For the method of preparing the core shell structure using a high-refractive index particle as the core, the techniques described in Japanese Patent Application Laid-Open (JP-A) Nos. 2001-166104 and U.S. Patent Application No. 2003/0202137 can be used.

Further, examples of the method of using a specific dispersing agent in combination include techniques described in Japanese Patent Application Laid-Open (JP-A) No. 11-153703, U.S. Pat. No. 6,210,858 and Japanese Patent Application Laid-Open (JP-A) No. 2002-2776069.

For materials used for forming a matrix, thermoplastic resins and curable resin films are exemplified.

Further, it is preferable to use at least one composition selected from polyfunctional compound compositions containing two or more radically polymerizable and/or cationic polymerizable groups, organic metal compounds containing a hydrolyzable group, and partially condensate compositions thereof. Examples of the composition include the compounds described in Japanese Patent Application Laid-Open (JP-A) Nos. 2000-47004, 2001-315242, 2001-31871 and 2001-296401.

Furthermore, colloidal metal oxides obtainable from hydrolyzed condensates of metal alkoxide and curable films obtainable from metal alkoxide compositions are also preferable. Examples thereof include the compositions described in Japanese Patent Application Laid-Open (JP-A) No. 2001-293818.

The refractive index of the high-refractive index layer is preferably 1.70 to 2.20. The thickness of the high-refractive index layer is preferably 5 nm to 10 μm and more preferably 10 nm to 1 μm.

The refractive index of the medium refractive index layer is controlled so as to be a value between the refractive index of the low-refractive index layer and the refractive index of the high-refractive index layer. The refractive index of the medium refractive index layer is preferably 1.50 to 1.70. The thickness of the medium refractive index layer is preferably 5 nm to 10 μm and more preferably 10 nm to 1 μm.

### —Low-Refractive Index Layer—

The low-refractive index layer is preferably laminated on the high-refractive index layer. The refractive index of the low-refractive index layer is preferably 1.20 to 1.55 and more preferably 1.30 to 1.50.

The low-refractive index layer is preferably structured as the outermost surface layer to obtain abrasion resistance and antifouling performance. As a method to greatly increase abrasion resistance, it is effective to impart slippage to the outermost surface, and a thin layer doped with a silicone compound or a fluorine-containing compound is preferable to impart slippage.

The refractive index of the fluorine-containing compound is preferably 1.35 to 1.50 and more preferably 1.36 to 1.47. For the fluorine-containing compound, a compound containing fluorine atom in the range of 35% by mass to 80% by mass and containing a crosslinkable or polymerizable functional group is preferable.

Examples thereof include the compounds described in Paragraph Nos. to [0026] in Japanese Patent Application Laid-Open (JP-A) No. 9-222503, Paragraph Nos. [0019] to [0030] in Japanese Patent Application Laid-Open (JP-A) No. 11-38202, Paragraph Nos. [0027] to [0028] in Japanese Patent Application Laid-Open (JP-A) No. 2001-40284, and the compounds described in Japanese Patent Application Laid-Open (JP-A) Nos. 2000-284102 and 2004-45462.

For the silicone compound, it is preferably a compound having a polysiloxane structure, containing a curable functional group or a polymerizable functional group in a high-molecular chain and having a crosslinked structure in the film. For example, reactive silicones [such as SYRAPLANE (manufactured by CHISSO CORPORATION) and polysiloxane containing a silanol group at both ends thereof (Japanese Patent Application Laid-Open (JP-A) No. 11-258403)] are exemplified.

The crosslinking reaction or polymerization reaction of polymer containing fluorine and/or siloxane having a crosslinkable or polymerizable group is preferably carried out by irradiating with light and/or heating a coating composition used for forming the outermost surface layer containing a polymerization initiator, a sensitizer and the like, at the same time of the coating process or after the coating process. For the polymerization initiator and the sensitizer, those known in the art can be used.

Further, for the low-refractive index layer, a sol-gel cured film that is cured by subjecting an organic metal compound such as silane coupling agent and a silane coupling agent containing a specific fluorine-containing hydrocarbon group to a condensation reaction in co-presence of a catalyst is preferable. Examples thereof include polyfluoroalkyl group-containing silane compounds or partially hydrolyzed condensates (the compounds described in Japanese Patent Application Laid-Open (JP-A) Nos. 58-142958, 58-147483, 58-147484, 9-157582, 11-106704); and silyl compounds containing a poly-‘perfluoroalkylether’ group that is a fluorine-containing long-chain group (the compounds described in Japanese Patent Application Laid-Open (JP-A) Nos. 2000-117902, 2001-48590, and 2002-53804).

It is preferable that besides the above-mentioned additives, the low-refractive index layer contain a low-refractive index inorganic compound having an average primary particle diameter of 1 nm to 150 nm such as fillers (for example, silica dioxide, and fluorine-containing particles (for example, fluorinated magnesium, fluorinated calcium, and fluorinated barium)).

Particularly, it is preferable to use a hollow inorganic fine particle in the low-refractive index layer to further suppress the increase in refractive index. The refractive index of the hollow inorganic fine particle is preferably 1.17 to L40, more preferably 1.17 to 1.37, and still more preferably 1.17 to 1.35. The refractive index described here indicates a refractive index as an entire particle and does not indicate a refractive index of only the outer-shell forming the hollow inorganic fine particle.

The average particle diameter of the hollow inorganic fine particle in the low-refractive index layer is preferably 30% to 100% of the thickness of the low-refractive index layer, more preferably 35% to 80%, and still more preferably 40% to 60%.

Specifically, when the thickness of the low-refractive index layer is 100 nm, the particle diameter of the inorganic fine particle is preferably 30 nm to 100 nm, more preferably 35 nm to 80 nm, and still more preferably 40 nm to 60 nm.

The refractive index of the hollow inorganic fine particle can be measured using an Abbe refractometer (manufactured by ATAGO Co., Ltd.).

For the other additives, the low-refractive index layer may contain the organic fine particles described in Paragraph Nos. [0020] to [0038] in Japanese Patent Application Laid-Open (JP-A) No. 11-3820; silane coupling agents, lubricants, surfactants etc. described in Paragraph Nos. [0020] to [0038] in Japanese Patent Application Laid-Open (JP-A) No. 11-3820.

When the low-refractive index layer is positioned as an under layer of the outermost surface layer, the low-refractive index layer may be formed by a gas-phase method (for example, vacuum evaporation method, sputtering method, ion-plating method, and plasma CVD method), however, it is preferably formed by a coating method, in terms of its cheap production cost.

The thickness of the low-refractive index layer is preferably 30 nm to 200 nm, more preferably 50 nm to 150 nm, and still more preferably 60 nm to 120 nm.

### —Uses of Glass—

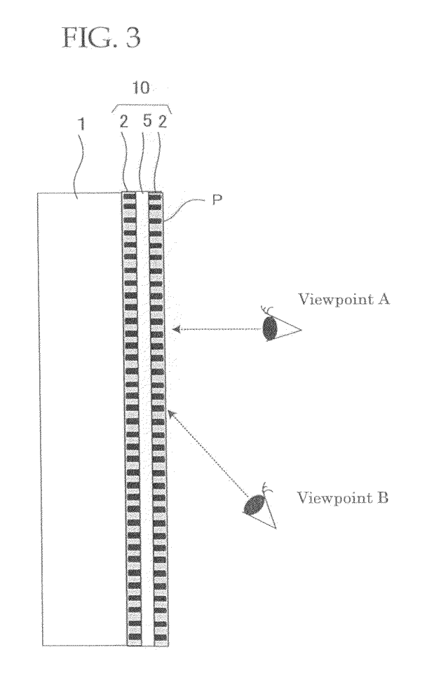

The glass of the present invention, as shown in FIG. 3, does not absorb visible light from the front direction because the absorption axis of a polarizer P in an optical film 10 is substantially perpendicularly to the glass substrate surface, but can prevent room temperature from increasing because the glass absorbs light from oblique directions.

Further, when outside scenery is viewed from a substantially front direction through the glass, as shown in a viewpoint A in FIG. 3, the outside scenery is viewable, however, when viewed from an oblique direction as shown in a viewpoint B in FIG. 3, the outside scenery is not viewable because it is seen as darkness. It is possible to obtain a glass partition that the way outside scenery is seen is changed depending on the angle that the glass is viewed.

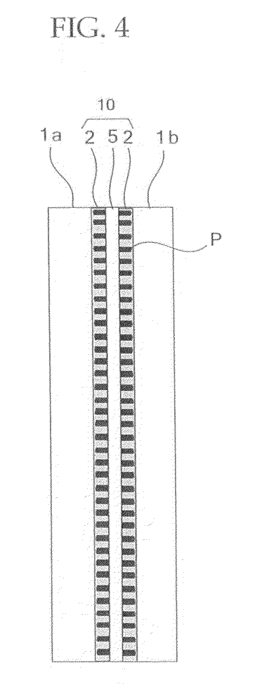

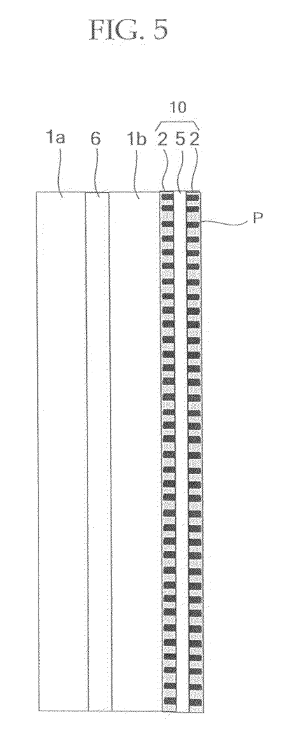

When the glass of the present invention is used as windowpane, the optical film 10 is preferably formed, as shown in FIG. 3, on a surface (back surface) of a substrate glass 1 constituting the windowpane, on which sunlight is not incident. In a case of a laminated glass having an intermediate layer between two sheets of plate glasses 1a, 1b, the optical film 10 is preferably structured as follows. As shown in FIG. 4, optical films (2, 5, 2) are preferably included in an intermediate layer or as shown in FIG. 5, optical films (2, 5, 2) are preferably formed on a surface (back surface) of the laminated glass, on which sunlight is not incident.

Because the glass of the present invention has an excellent partition effect and allows for reducing light intrusion into indoor rooms and preventing increases in room temperature, the glass can be suitably used in opening portions and partitions of buildings of typical single houses, collective housings, office building, stores, public facilities, plant equipment and the like, and further, can also be suitably used for automobile windows, vehicle windows, ship and vessel windows, airplane windows and the like.

The present invention can solve conventional problems and provide an optical film and a glass that can drastically reduce light intrusion into indoor rooms from outside light by placing the optical film at the front of a plasma display or a liquid crystal display to thereby improve brightness contrast in the room, and when used as building glass such as windowpane, they allow for absorbing sunlight incoming from oblique directions to thereby prevent increases in room temperature and also allows for exhibiting an excellent partition effect that indoor rooms can be seen from the front view but cannot be seen from oblique angles because the indoors are seen as darkness.

### EXAMPLES

Hereinafter, the present invention will be further described in detail referring to specific Examples, however, the present invention is not limited to the disclosed Examples.

### Example 1

### Preparation of Half-Wavelength Plate

A polycarbonate film (brand name: PURE ACE, manufactured by Teijin Chemicals, Ltd.) was heated and drawn to set the birefringence value (retardation value at a wavelength of 550 nm) at 275 nm and to thereby prepare a half-wavelength plate.

<Preparation of Film Formed with Polarized Film in which a Dichroic Pigment is Oriented, by Guest-Host Method>

### —Formation of Polarized Film—

The both surfaces of the half-wavelength plate was spin-coated with a oriented film solution of polyvinyl alcohol (PVA) (methanol solution) at 1,000 rpm for 30 seconds and then dried at 100° C. for 3 minutes to thereby prepare a perpendicularly oriented film of PVA having a thickness of 1.0 μm.

### —Preparation of Polarized Film Coating Solution—

To a liquid crystal solution in which 3.04 g of a liquid crystal compound (brand name: PALIOCOLOR LC242, manufactured by BASF Corporation) having a photo-polymerizable group was dissolved in 5.07 g of methylethylketone (MEK), 1.11 g of an initiator solution [0.90 g of IRGACURE 907 (manufactured by Chiba Specialty Chemicals K.K.) and 0.30 g of KAYACURE DETX, manufactured by Nippon Kayaku Co., Ltd.) were dissolved in 8.80 g of methylethylketone (MEK)] was added. The components were stirred for 5 minutes to be fully dissolved.

Next, 0.15 g of dichroic pigments [G205 and G472, manufactured by Hayashibara Biochemistry Laboratories Inc., were mixed at a mixing ratio of 1:2 (mass ratio)] was added to the obtained solution, and the components were stirred for 5 minutes to thereby prepare a polarized film coating solution. Note that G205 and G472 are both azo pigments.

### —Orientation and Curing of Dichroic Pigment—

The half-wavelength plate formed with PVA oriented film was spin-coated with the obtained polarized film coating solution at 500 rpm for 15 seconds, then put on a hot plate so that the opposite surface from the coated surface was made contact with the hot plate surface. The half-wavelength plate was dried at 90° C. for 1 minute and irradiated with an ultraviolet ray (UV) (using a high-pressure mercury lamp (1 kW, 330 mJ/mm²)) in heated state to thereby form a polarized film of 2.5 μm in thickness in which the dichroic pigments were substantially perpendicularly oriented. The polarized film was formed on the both surfaces of the half-wavelength plate. With the above-mentioned process, an optical film of Example 1 was prepared.

### <Orientation of Dichroic Pigment>

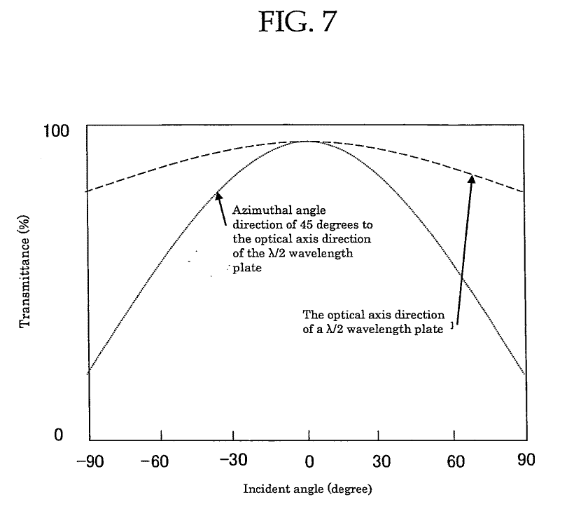

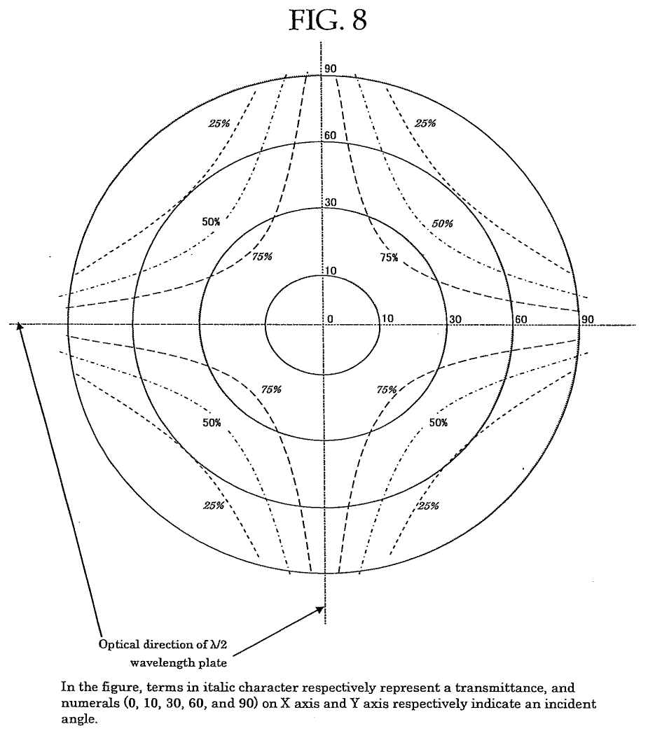

Transmittance property of the obtained optical film was measured with changing the incident angle of test light to the film. FIG. 7 shows the measurement results. As shown in FIG. 7, as the incident angle increases, the transmittance remarkably decreases. FIG. 8 is a concentric graph of results of the transmittance of the optical film of Example 1 measured in all azimuthal directions. As shown in FIG. 8, when an azimuthal angle faces the optical axis of the half-wavelength plate, the transmittance is modestly reduced, however, largely reduced as compared to that of a commonly used simple color film. A specific point is that when an azimuthal angle faces an angle of 45 degrees to the optical axis of the half-wavelength plate, the transmittance remarkably decreases as the incident angle increases. With increased thickness of the polarized film, it is possible to make the quantity of transmitting light reduced to near zero.

### —Evaluation of Optical Properties—

The partition effect and light-resistance of the obtained optical film were evaluated as follows. Table 1 shows the evaluation results.

### <Evaluation of Partition Effect>

The incident angle dependency relating to the transmittance of the obtained optical film was very unique. Even when the elevation angle is slanting in two directions, i.e., in the phase advance axis direction and the retard phase axis direction of a half-wavelength plate used, the transmittance is modestly reduced, and the half-wavelength plate is only a film in which the polarizer is perpendicularly oriented. However, optical properties of the half-wavelength plate works maximally in azimuthal angle directions passing the intermediate zone between the phase advance axis direction and the retard phase direction, and the transmittance rapidly decreases as the elevation angle is reduced, and the transmittance can be reduced to 10% or less. Therefore, in the evaluation of partition effect, the phase advance angle and an azimuthal angle facing an angle of 45 degrees to the optical axis of the half-wavelength plate were defined as azimuthal angles, the elevation angle was determined to 45 degrees, and light transmittances of visible light from the incident angles were measured to thereby evaluate the partition effect. A larger value indicates that the test sample has a greater partition effect.

### <Evaluation of Light Resistance>

The half-wavelength plate was subjected to a light-irradiation test using an ultra-high-pressure mercury lamp, and the light resistance thereof was evaluated based on changes in the partition effect after irradiation for 1,000 hours.

### Example 2

### Preparation of Film Formed with Polarizer in which a Gold Nano-Rod is Oriented, By Anodic Oxidation Alumina Method

—Formation of Half-Wavelength Plate Formed with Transparent Conductive Film—

A polycarbonate film (brand name: PURE ACE, manufactured by Teijin Chemicals, Ltd.) was heated and drawn to set the birefringence value (retardation value at a wavelength of 550 nm) at 275 nm and to thereby prepare a half-wavelength plate. On the both surfaces of the half-wavelength plate, an ITO (Tin-doped Indium oxide) film was formed so as to form a film thickness of 120 nm to thereby prepare a half-wavelength plate formed with a transparent conductive film of 10 Ω/square in resistivity.

### —Formation of Aluminum-Deposited Film—

On a surface of the transparent conductive film of the half-wavelength plate formed with the transparent conductive film, an aluminum-deposited film having a film thickness of 150 nm was formed by RF sputtering method.

—Formation of Nanoholes by Anodic Oxidation—

The laminate composed of the aluminum-deposited film and the half-wavelength plate formed with the transparent conductive film was electrolyzed at a constant voltage of DC 10V for 30 minutes in oxalic acid aqueous solution of 0.3M to prepare an anodic oxidation film with nanoholes formed on the surface thereof. The nanoholes had an average aperture diameter of 20 nm, an average depth of 100 nm and an average aspect ratio of 5.

### —Formation of Gold Nano-Rod by Electroforming—

The anodic oxidation film with nanoholes formed thereon was electrolyzed with an AC of 10V for 10 minutes in 0.5 mM of HAuBr₄ aqueous solution whose pH was adjusted to 2.5 with H₂SO₄ under the condition where the aqueous solution temperature was set at 20° C. to electrodeposit gold nano-rods in the nanoholes of the anodic oxidation film.

Note that a counter electrode used in the electrolyzation was a carbon plate. The length of the gold nano-rods to be electrodeposited was non-uniform, and thus there were portions where gold overflowed on the surface of the anodic oxidation film. Then, the surface of the anodic oxidation film was slightly ground by inversely sputtering the film a little bit in the last instance to thereby make the length of nano-rods uniform.

### <Orientation of Gold Nano-Rods>

A slice of the obtained anodic oxidation film was observed using a transmission electron microscope (TEM), it was found that 80 number % or more of absorption axes of 500 pieces of gold nano-rod were oriented at 85 degrees to 90 degrees to the horizontal surface of the film.

The partition effect and light resistance of the obtained optical film of Example 2 were evaluated in the same manner as in Example 1. Table 1 shows the evaluation results.

### Example 3

### Preparation of Laminated Glass

The optical film of Example 1 was sandwiched in between two sheets of transparent PVB films, further both surfaces of the PVB films were covered with a float glass, the laminate was put in a rubber bag, the rubber gag was deaerated at a vacuum degree of 2,660 Pa for 20 minutes and placed in an oven in a state of being deaerated and further subjected to a vacuum press while maintaining the temperature of 90° C. for 30 minutes. The laminated glass that was preliminarily bonded as above was pressure-bonded in an auto-clave for 20 minutes under the conditions of 135° C. and a pressure of 118N/cm² to thereby prepare a laminated glass.

The partition effect and light resistance of the obtained laminated glass were evaluated in the same manner as in Example 1. Table 1 shows the evaluation results.

### Comparative Example 1

### Preparation of Optical Film

An optical film of Comparative Example 1 was prepared in the same manner as in Example 1 except that a polarizer with a dichroic pigment oriented on the surface thereof was not formed.

The partition effect and light resistance of the obtained optical film were evaluated in the same manner as in Example 1. Table 1 shows the evaluation results.

### Comparative Example 2

### Preparation of Laminated Glass

A laminated glass of Comparative Example 2 was prepared in the same manner as in Example 3 except that a polarized plate composed of iodine and PVA (manufactured by Sanritz Corporation) was used as a polarizer.

The partition effect and light resistance of the obtained laminated glass were evaluated in the same manner as in Example 1. Table 1 shows the evaluation results.

TABLE 1

| | | Light |
|---|---|---|
| | Partition effect | resistance |
| Ex. 1 | 7% | 11% |
| Ex. 2 | 3% | 3% |
| Ex. 3 | 7% | 8% |
| Compara. | 82% | 82% |
| Ex. 1 | | |
| Compara. | 43% | 76% |
| Ex. 2 | | |

### INDUSTRIAL APPLICABILITY

The glass of the present invention has an excellent partition effect and allows for reducing light intrusion into indoor rooms and preventing increases in room temperature, the glass can be suitably used in opening portions and partitions of buildings of typical single houses, collective housings, office building, stores, public facilities, plant equipment and the like, and further, can also be suitably used for automobile windows, vehicle windows, ship and vessel windows, airplane windows and the like.

1. An optical film, comprising:
a phase difference film, and
a polarized film formed on both surfaces of the phase difference film, wherein the polarized film comprises at least a polarizer, and the absorption axis of the polarizer is substantially perpendicularly oriented to the polarized film surface.

2. The optical film according to claim 1, wherein the phase difference film is a half-wavelength plate.

3. The optical film according to claim 1, wherein the absorption axis of the polarizer is oriented at an angle of 80 degrees to 90 degrees to the polarized film surface.

4. The optical film according to claim 1, wherein the polarizer comprises an anisotropically absorbing material.

5. The optical film according to claim 4, wherein the anisotropically absorbing material is any one of a dichroic pigment, an anisotropic metal nano particle and a carbon nanotube.

6. The optical film according to claim 5, wherein the material of the anisotropic metal nano particle is at least one selected from gold, silver, copper and aluminum.

7. The optical film according to claim 1, being placed at the front of a plasma display or a liquid crystal display.

8. A glass, comprising:
a substrate, and
an optical film,
wherein the optical film comprises a phase difference film, and a polarized film formed on both surfaces of the phase difference film,
wherein the polarized film comprises at least a polarizer, and the absorption axis of the polarizer is substantially perpendicularly oriented to the polarized film surface, and
wherein when the glass is placed so that sunlight is incident from one surface of the substrate, the optical film is formed on the surface of the substrate on which sunlight is not incident on.

9. The glass according to claim 8, wherein the substrate is a laminated glass in which an intermediate layer is formed in between two sheets of plate glasses, and the intermediate layer comprises the optical film.
